(19) United States
(12) Patent Application Publication
(10) Pub. No.: US 2022/0230154 A1
(43) Pub. Date: Jul. 21, 2022

(54) METHOD AND SYSTEM TO DYNAMICALLY ROUTE FUNDING TO VIRTUAL PAYMENT CARDS TO RESELL SUBSCRIPTION MERCHANDISE

(71) Applicant: APPBIND INC., Atherton, CA (US)

(72) Inventors: SUNIR SHAH, Toronto (CA); JOSEPH K. DENNIS, Atherton, CA (US)

(21) Appl. No.: 17/711,089

(22) Filed: Apr. 1, 2022

Related U.S. Application Data
(63) Continuation of application No. 16/963,719, filed on Jul. 21, 2020, now abandoned.
(60) Provisional application No. 62/625,934, filed on Feb. 2, 2018.

(51) Int. Cl. G06Q 20/14; G06Q 10/10; G06Q 20/10; G06Q 20/24; G06Q 30/04

(52) U.S. Cl. CPC G06Q 20/14; G06Q 10/10; G06Q 30/04; G06Q 20/24; G06Q 20/102

(57) ABSTRACT

A method and system to dynamically route funding to virtual payment cards to resell subscription merchandise is disclosed. For example, the method associates a payment source and a payer with a virtual payment card. Then, receiving a charge for a subscription fee, the subscription fee for a subscription merchandise for the payer, the charge applied to the virtual payment card for the subscription fee initiated by the merchant, through a payment network. Next, determining the payer and a markup for each payer related to the subscription fee, calculating a total payer charge amount for each payer from the subscription fee and the markup for each payer, determining a portion amount of the total payer charge amount to be charged to each payment source of the payer, charging the portion amount to the payment source, and, determining if the charge is authorized.

### CROSS REFERENCES TO RELATED APPLICATIONS

This application is a continuation application of U.S. application Ser. No. 16/963,719 filed on 21 Jul. 2020, which claims priority to International Application Serial Number PCT/US2019/016262 filed Feb. 1, 2019, which in turn claims priority to U.S. Provisional Application Ser. No. 62/625,934, filed Feb. 2, 2018, the entirety of each is herein incorporated by referenced.

### BACKGROUND

Many products rely on subscription billing models. Examples include, but are not limited to, Internet software services that use a subscription billing model to license use of the software.

Typically, a merchant selling subscription merchandise will take a payment card as a method of payment from a licensee. This licensee is typically the end customer. The payment card is held on file by the merchant or its billing system in order to repeatedly charge the card during the lifetime of the subscription. For instance, the merchant could charge a monthly recurring fee, a series of one-time fees, or a variable fee based on how the end-customer uses the subscription merchandise.

However, this billing model does not support the use case when a third party wishes to act as an intermediary to sell the subscription merchandise to an end customer—for instance, an agency that wishes its clients use a recommended subscription Internet software. Fundamentally, a card subscription creates a direct, fixed, non-transferrable relationship between the merchant and its subscriber, thereby disintermediating any middle parties in the transaction.

This limits the distribution of subscription merchandise.

Some common workarounds to the problems identified above include:

Direct referral of end customer to merchant: The intermediary can refer the end customer directly to the merchant. The customer will subscribe directly to the subscription merchandise. It may be the case that this referral will earn a referral commission for the intermediary if the intermediary has a referral contract with the merchant.

Otherwise, the intermediary will not earn any revenue for the referral. The end customer may deal directly with the merchant going forward without further need of the intermediary. The incentives, then, for an intermediary to directly refer an end customer to a merchant are low. This is because of the low rate of economic return and even potential economic threat of losing a customer.

Resell a merchant's subscription merchandise: An intermediary can act as a reseller. It can subscribe to subscription merchandise using its (i.e., the reseller's) own payment source and enter into a contract with the end customer. The reseller then invoices the end customer for the subscription merchandise. The reseller has the option to mark up the charges or bundle several subscription merchandises (provided by one or more merchants) and/or professional services together as part of a larger package of services.

However. the reseller may be exposed to financial risk if the subscription merchandise charges vary, and in particular if they increase. A common solution is to book incoming charges from subscription merchandise as expenses to put on the next invoice to the end customer. This could leave the reseller extending credit to the end customer between the time the charge comes from the merchant and the time the end customer pays their invoice.

Further, the intermediary is exposed to risk if the end customer charges back the transaction through the payment card network. The reseller in this case will be left funding the transaction unless it can charge back the merchant in return. The merchant may also refund a transaction. If the contract with the end customer is a markup of the charge from the merchant, this refund may also be owed in turn to the end customer.

The reseller may also need to charge taxes to the end customer for either the underlying charge, their markup fees, or both.

The reseller will often use its own payment card to purchase all end customer subscriptions. This mixes charges for potentially several end customer subscriptions with the reseller's own business expenses in the same payment card transaction history, making it difficult to ascertain which charge is associated with which end customer, or with the reseller's business itself.

Finally, this system is sensitive to any interruptions. For instance, the reseller's payment card may be cancelled, lost, stolen, suspended, or hit its credit limit, preventing further charges from being made. This can cause suspensions across the reseller's portfolio of end customers' subscription merchandise. In another case, the contract between end customer and reseller may be terminated or assigned, but with the agreement that the end customer maintains business continuity with subscription merchandise. In both of these cases, every single merchant for affected end customers must have the payment card on file updated manually with a new payment card.

Upon termination, a reseller may alternatively wish to cancel all subscriptions belonging to the end customer. It must manually go to each subscription merchandise and cancel them.

### SUMMARY

In an aspect, a method is provided, the method comprising: associating a payment source and a payer with a virtual payment card, the virtual payment card from an issuer, and, the payment source provided by the payer; receiving a charge for a subscription fee, the subscription fee for a subscription merchandise for the payer, the subscription merchandise provided by a merchant, the charge applied to the virtual payment card for the subscription fee initiated by the merchant, through a payment network, the charge received by the issuer of the virtual payment card; determining the payer and a markup for each payer related to the subscription fee; calculating a total payer charge amount for each payer from the subscription fee and the markup for each payer; determining a portion amount of the total payer charge amount to be charged to each payment source of the payer; charging the portion amount to the payment source; determining if the charge request is authorized.

In another aspect, a system is provided, the system comprising: A rebilling system, comprising: a database; a server, the server operatively connected to the database, the server configured to: associate a payment source and a payer with a virtual payment card, the virtual payment card from an issuer, and, the payment source provided by the payer; receive a charge for a subscription fee, the subscription fee for a subscription merchandise for the payer, the subscription merchandise provided by a merchant, the charge applied to the virtual payment card for the subscription fee initiated by the merchant, through a payment network, the charge received by the issuer of the virtual payment card; determine the payer and a markup for each payer related to the subscription fee; calculate a total payer charge amount for each payer from the subscription fee and the markup for each payer; determine a portion amount of the total payer charge amount to be charged to each payment source of the payer; charge the portion amount to the payment source; determine if the charge request is authorized.

It will be appreciated that managing the flow of charges, refunds, chargebacks, markups, taxes, cancellations, and assignment creates significant friction for resellers, especially if they must manage the process manually.

A typical virtual payment card is either loaded with pre-paid funds; or it is bound to another payment source such as another payment card (a host card) or an underlying bank account which funds transactions as they are charged against the virtual payment card.

The rebilling system described in this patent allows for virtual payment cards that are not bound to a fixed funding source or even any funding source upon their issuance. The rebilling system allows for the funding source may be rebound as desired over the lifetime of the virtual payment card.

Further, the rebilling system allows a virtual payment card to be bound to multiple payment sources from a single or multiple parties. If multiple parties are involved, obligations for use of their funding sources (such as mark ups, fees, sales taxes, authorization, spending controls, etc.) can be automatically processed by the rebilling system.

In order to achieve this, the rebilling system uses virtual payment cards to accept and respond to requests from over a payment network (such as charge requests, settlements, refunds, chargebacks). These requests are then processed by the rebilling system to generate new payment requests that can be forwarded onto separate parties. The rebilling system allows for the dynamic configuration of these routes and associated obligations and controls.

As an analogy, the rebilling system is similar to how a phone number can be virtual and disassociated from an underlying physical phone handset. Calls to this virtual phone number can then be routed dynamically to any number of physical phones owned by any party, which each may have their own separate phone numbers. However, as virtual payment cards are a monetary instrument, managing the financing and accounting of transactions requires additional complexity.

Some use cases the rebilling system enables include:

Automating the expensing of subscriptions or other merchandise purchased by a reseller to an end customer, including automating mark ups, fees, sales taxes, spending controls, and other obligations and controls; and subsequently automating the processing of refunds and chargeback.

Reassigning the payer associated with a subscription by changing the payer associated with the virtual payment card in order to reflect a change in ownership of the subscription.

Providing merchants selling subscription merchandise a means to enable resale of their subscriptions without modification of their existing billing system or creation of a separate billing system since the rebilling system is directly compatible with the existing payment card networks (e.g. Visa, Mastercard) their billing system uses.

Supporting multiple intermediaries to act as a distribution chain to resell subscriptions by attaching each party to the virtual payment card and automating each party's mark ups, fees, sales taxes, spending controls, and other obligations and controls.

Providing operational continuity of subscription services by binding multiple payment sources to the virtual payment card and automatically rerouting funding in case one payment source fails.

Mass cancellation of subscriptions by a given party in one place, for instance if the relationship between an end customer and reseller ends, the reseller can deactivate all the virtual payment cards associated with that end customer to stop payment and thereby cancel subscriptions from the rebilling system.

The present disclosure also allows merchants to sell subscriptions without requiring modification of their billing system (or creating a reseller portal) to support third parties reselling their subscription merchandise. A potential reseller using the rebilling system does not require a special (e.g. contractual) relationship with the merchant to resell their software since they can purchase the subscriptions using the merchant's already existent and available-in-market payment card billing system. Furthermore the rebilling system does not restrict billing models or changes to billing models of the underlying subscription because it only processes each individual payment request generated by the billing model. This lowers costs and barriers to both resellers and merchants to distribute subscription merchandise.

The rebilling system further acts as intermediary between the merchant and the end customer, such as the Apple App Store, AppDirect, Shopify App Store and others. In these cases, the marketplaces require a direct relationship with the merchant. In order to support automated billing, the merchant has to modify their billing system to integrate with the marketplace billing system, and may be limited to the billing models supported by the marketplace.

If the marketplace billing system does not implement a billing model, such as recurring billing, tiered billing, metered billing, one-time charges, etc., that billing model will not be available to the merchant in that marketplace channel. Further, if the merchant wants to change their billing model in the future, or even manage day-to-day administration like refunds or discounts or credits, they will have to expend resources managing the marketplace billing system in addition to their own.

In other subscription resale cases (such as telephony resale or insurance resale) Third Party Administrators (TPAs) often act as an intermediary to manage subscription rebilling by building their own billing system between the main supplier (e.g. a telephone carrier, insurance underwriter) and the resellers, and it must maintain contractual relationships with entities higher in the supply chain.

The rebilling system improves on this model by making it unnecessary to implement a complex billing model at the TPA and also allowing them to support any third-party supplier who provides subscription merchandise freely in the market, or if they enter into a supplier agreement, without requiring direct integration of billing systems. Instead they can rely on the existing payment card network infrastructure and the rebilling system to manage the flow of funds.

The rebilling system uses an Issuer to generate unique virtual payment cards.

The virtual payment card is used at a merchant that accepts payment cards to make either one-time payments or a series of payments associated with a subscription.

Before authorizing the charge, the rebilling system has the opportunity to apply business rules. These business rules include, but are not limited to adding mark ups, fees, sales taxes; applying spending controls, and authorizing charges.

The rebilling system automatically charges the payment sources bound to the virtual card. In various embodiments, the choice of which payment sources are charged may be in ordered priority, round robin, based on available credit, timeliness, or other policies configured in the rebilling system.

The rebilling system automates the forwarding of chargebacks and refunds for charges on the virtual payment card and manage the settlement of funds thereof.

### BRIEF DESCRIPTION OF THE FIGURES

FIG. 1 depicts a block diagram of an embodiment rebilling system

FIG. 2 depicts a block diagram of the rebilling system of FIG. 1 interfacing with an issuer

FIG. 3 depicts a block diagram of the rebilling system of FIG. 1 interfacing with an issuer, merchant, and a payer.

FIG. 4A depicts an embodiment method for rebilling.

FIG. 4B depicts an alternate embodiment method for rebilling.

FIG. 5A depicts an embodiment authorization logic for the method of FIG. 4

FIG. 5B depicts an alternate embodiment authorization logic for the method of FIG. 4

FIG. 6 depicts an alternate embodiment method for rebilling.

FIG. 7 depicts an alternate embodiment method for rebilling.

FIG. 8 depicts an embodiment method for bundle rebilling.

FIG. 9 depicts an embodiment method for processing refunds.

FIG. 10 depicts an embodiment method for processing chargebacks.

### LISTING OF REFERENCE NUMERALS USED IN THE DRAWINGS

1 merchant initiated charge request
2 transmit through payment network
100 Rebilling System
102 Rebilling System Server
103 Payment from another source?
104 Dunning
105 capture payer funds
106 Funds
108 Issuer/Virtual Payment card issuer
112 payment network
114 payer/Customer
116 merchant/SaaS App/Provider
118 Rebilling System Database
120 network
130 transfer funds from payer
150 authorization logic
152 check float fund
154 check other payment sources for fund availability
156 check customer payment source for authorization
158 check reseller payment source for authorization
160 payer timeout
162 Is payment authorized?
164 check customer fund
166 check reseller fund
168 check distributor fund
200 payment request/receiving a request for payment from a merchant through a virtual payment card provided by a virtual payment card issuer
201 authorization
202 total charge/calculate total charge
203 capture funds
204 authorize
205 transfer funds to merchant
208 transmit
210 transmit capture request
301 payer funds received
302 settle markups
303 transfer markups
304 reimburse float fund
400 reseller fund
401 decline message
402 distributor fund
403 payment declined
404 tax fund
406 other parties' fund
408 fees fund
410 settlement fund
412 payer fund/payer account
416 float fund
418 rebilling system-controlled fund
420 customer fund
450 transmit decline message
501 initiate refund charge
502 transmit over payment network
503 transfer funds to rebilling system
504 refund transferred
601 retrieve charge record
602 refund float
603 lookup markups
604 refund markups
605 refund payer
650 processing (by the rebilling system)
652 authorizing the payment request (by the rebilling system)
654 transferring
701 initiate chargeback
702 receive chargeback request
703 retrieve charge record
704 determine whether to dispute charge
705 dispute charge
801 forward chargeback
802 transmit chargeback through payment network
803 receive chargeback request at merchant
804 dispute with system
805 transmit dispute
806 delegate dispute
807 merchant dispute resolution
850 bundle billing request
852 payer authorizes bundle request
854 receive authorization
856 capture request
858 distribute funds
860 rebilling system account
862 reseller's account
864 distributor's account
866 holding account
868 initiate payment request
870 send authorization
872 funds capture request
874 funds transfer
876 receive payment
900 merchant fund
950 merchant initiated charge request
952 MARQETA receives authorization request, calls APPBIND gateway
954 gateway receives authorization request, return approval, initiates async funding
956 MARQETA returns approval
958 Authorization response received, if approved submit capture request
960 deduct amount from program funding source, complete SaaS app transaction
962 SaaS receives payment
968 Calculate fees/markup
970 call MARQETA GPAORDER API to bill customer's payment source
972 customer payment source billed, moves funds
974 transfer reseller markup
976 transfer distributor markup
978 transfer rebilling system and SaaS App fees
980 transfer to program funding source (float fund)
982 rebilling fund

### DETAILED DESCRIPTION

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It will be understood that the invention is limited to the subject matter provided by the claims, and that the invention is not limited to the particular aspects depicted and described.

### Definitions

Subscription merchandise. A product or service whose license for use depends in whole or in part on maintaining an active subscription.

Merchant. The producer or seller of the subscription merchandise.

Subscription. A contract for licensed use that may be “deactivated” (e.g. by termination, suspension, or for other means or purposes), upon which time the license shall be revoked or suspended or otherwise deactivated.

Card subscription. A subscription that applies charges for the contract on a payment card.

Subscriber. The party which contracts with the merchant to enter into a subscription.

Payment card. A credit or debit card.

Payment source. Any method of payment, such as but not limited to a payment card, Automated Clearing House (ACH), Electronic Fund Transfer (EFT).

Virtual payment card. Virtual payment cards are a set of data relevant to a physical payment card (for examples, card number, expiration date, billing name, billing address, security codes), which may be issued as needed facilitate online transactions.

Charge. A monetary liability (e.g. a fee) accrued on a payment source.

One-time charge. A charge accrued only once.

Recurring charge. A set of charges agreed in advance to be accrued over time.

End customer. The party for whose intended primary use the subscription merchandise is provisioned.

Agent. A third party which contracts a subscription from a merchant on behalf of an end customer. The charges accrue to the end customer directly.

Reseller. A third party which purchases a subscription from a merchant on behalf of an end customer. The legal relationships between parties may vary at their discretion. For example, the reseller may act as a purchasing agent, contracting the end customer with the merchant; or the reseller may enter into a contract with a merchant themselves and contract to invoice the customer separately; or the reseller may enter into a contract with another party that acts as a distributor selling on behalf of the merchant.

### Virtual Cards

Pre-paid virtual debit cards, a type of single-payer virtual payment card, can be used for Commercial Payments. Some virtual payment cards allow business logic to be applied. For instance, some solutions allow for business logic to control spending, monitor spending amounts, report expenses in an accounting system, limit maximum and minimum charges, look for statistically variant charges, lock a card to one merchant to prevent stolen cards from being used to buy elsewhere, limit the time a card is active, use a second factor (such as a text message or mobile device) to confirm purchases, and deactivate a virtual payment card to cancel or suspend a subscription without needing to cancel a payment source (such as a conventional credit card or bank account) linked to the virtual payment card.

Single-use pre-paid virtual payment cards are also widely available. These single-use prepaid cards can be used to pay suppliers in a business context. These are used by storing money on a virtual payment card and transferring the card to the supplier to claim payment through their existing credit card terminal. For the supplier this is faster, and for the buyer it is more secure (because payments are controlled, the numbers are controlled) and the payments are automatically entered into their accounting system. However these cards automatically cease to function once the first charge goes through. This makes them unsuitable for repeat charges.

Some subscription services require some ability to authenticate the subscriber. Often the required authentication requires the use of a real address. Virtual payment cards are generally not ideal for these situations. This is because pre-paid debit cards are both fungible (e.g. gift cards that do not have a fixed owner) and pseudonymous (as any billing name and address can be used). For these reasons many subscription services, such as GOOGLE GSUITE, do not accept virtual payment cards because they do not function as a sufficient means to authenticate the subscriber.

It will be appreciated that virtual payment cards are not always virtual debit cards. They can be created on other payment networks. For instance, services such as ABINE BLUE have the ability to create pre-paid virtual credit cards.

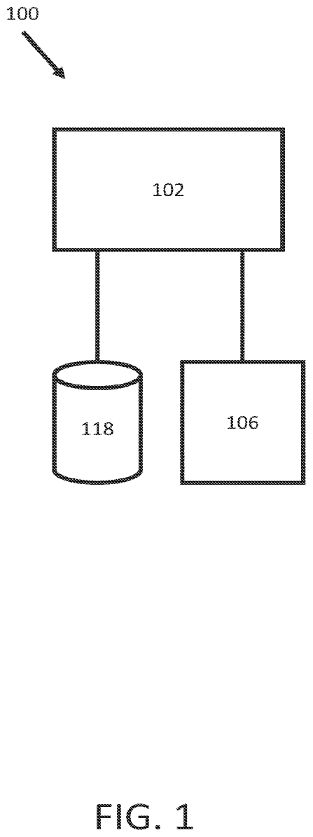

Referring now to FIG. 1, this figure depicts a block diagram of an embodiment rebilling system 100. The rebilling system 100 includes a rebilling system server (or server) 102, a rebilling system data store (or data store) 118, and funds 106 controlled or managed by the rebilling system 100.

In an embodiment the rebilling system 100 is connected to a computer network. This computer network is serves to communicatively connect computer systems, including payment networks, to each other. Example computer networks include, but are not limited to, public or private local area networks (LAN), public or private wide area networks (WAN), and the Internet.

The rebilling system server 102 is a computer system that interacts over a network with other systems. The server 102 is configured, among other things, to complete the rebilling transaction. The rebilling transaction includes, but is not limited to, sending, receiving, processing, and responding to payment requests to the virtual payment card.

In contrast to typical billing scenarios where the Issuer processes payment, the Issuer delegates (or routes) the payment request to the rebilling system 100. The processing is then performed by the rebilling system 100 rather than the Issuer's remittance processor. This allows, among other things, for the rebilling system 100 to apply markups.

The rebilling system server 102 also sends, receives, processes and responds to payment requests with the Payers' payment sources. It controls (e.g., can deposit and withdraw) the Float Fund 416, Settlement Fund 410, Markup Funds, and the Rebilling System Database.

In an embodiment the server 102 includes, among other things, a data store (such as a hard drive, solid state drive, network storage device, and/or a USB storage device), a processor, memory, and a network connection.

In other embodiments the server 102 is implemented virtually in a cloud computing environment where the functionality of the server is performed on one or more pooled computer resources that are accessible through a network and are managed by a cloud computing environment provider. Examples of cloud computing environments and their respective providers include, but are not limited, to, GOOGLE CLOUD COMPUTE, AMAZON AWS, and MICROSOFT AZURE.

The rebilling system 100 further includes a rebilling system data store 118. The rebilling system data store 118 stores, among other things, payer-related data, fund data, reseller data, merchant data, payment network data, accounting data, virtual payment card data, and any business rules necessary for processing the rebilling transaction.

In an embodiment the rebilling system data store 118 is implemented as a database that is stored on a storage device of the rebilling system server 102. These databases are managed by database management systems that are configured to run on the server 102. Examples of such database management systems and associated databases include, but are not limited to, MONGODB, MYSQL, MICROSOFT SQL SERVER, IBM DB2, ORACLE, and SQLITE.

In another embodiment the rebilling system data store 118 is implemented as a network-accessible data store hosted on a hosted data store provider. Examples of hosted data store providers include, but are not limited to, AMAZON AWS DATABASES, GOOGLE CLOUD DATASTORE, and MICROSOFT AZURE DATABASE.

The rebilling system data store 118 stores, among other things, virtual payment card data. This virtual payment card data includes, but is not limited to, details used by the payment network to effectuate payment at the point of sale to the merchant, and virtual payment card rebilling details.

The virtual payment card rebilling details provide virtual payment card details used by the rebilling system. This includes, but is not limited to, the virtual payment card number, the virtual payment card expiration date, the virtual payment card issuer, the virtual payment card's associated payment network, and the virtual payment card's security codes. It will be appreciated that the Issuer, who issues the virtual payment card, has a separate copy of the virtual payment card data for use on the payment network.

The rebilling system 100 also includes funds 106 that are controlled or managed by the rebilling system 100. These funds are used to collect, hold, and transfer funds (e.g., monetary instruments, money) between the rebilling system 100, the payer 114, the rebilling system 100, other parties, and the merchant 116. The rebilling system 100 is configured to be able to collect, hold, and transfer funds between these accounts to and from the payer 114, the rebilling system 100, other parties, and the merchant 116.

In an embodiment, the funds 106 include, but are not limited to, a Float Fund 416, a Settlement Fund 410, and one or more Markup Funds. The rebilling system 100 manages the transfer of funds between each Fund 106. The Settlement Fund 410 transacts with the Payer Fund 412. The Float Fund 416 transacts with the Merchant Fund 900.

A Fund is an account where money is deposited and/or withdrawn on behalf of an account owner. A Fund may be associated with an underlying bank account (or it may be a virtual account) whose balance and transaction history are recorded in the rebilling system database. The underlying bank account may be shared between multiple Funds. Virtual accounts may have negative balances depending on the rebilling system 100 policy. Funds that may be involved with the rebilling system, either as a component or externally through a direct or indirect interaction (e.g., API calls, interfacing with banking or account interfaces, etc), may include, but are not limited to:

The Float Fund 416—The Float Fund 416 holds money used to underwrite transactions. The Float Fund 416 can be provided by the rebilling system or a third party such as a Distributor or the Reseller themselves.

Payer Fund 412—The source bank account associated with a payment source. In some embodiments the rebilling system 100 can control or otherwise perform transactions (deposits, withdrawals, etc.) on the payer fund 412.

Merchant Fund 900—The destination bank account associated with a merchant. In some embodiments the rebilling system 100 can control or otherwise perform transactions (deposits, withdrawals, etc.) on the merchant fund 900.

Settlement Fund 410—. A bank account to receive funds transferred from the payers' payment sources. Because the money encompasses the total charge 202, it includes all markups and the requested amount 200, less any fees (e.g., payment, network, transaction), before being reallocated based on the markup model.

Markup Funds—These funds keep track of markups owed to parties using the rebilling system 100. These parties include, but are not limited to, Resellers funds 400, Distributors funds 402, or other parties funds 406. Other specific markup funds include:

The Fees Fund 408—The Fees Fund 408 keeping track of transaction fees charged by the rebilling system 100.

Tax Funds 404—The tax funds 404 keeps track of taxes owed by parties using the rebilling system 100.

It will be appreciated that the rebilling system 100 may not require every fund in every embodiment. For instance, in those embodiments where the rebilling system 100 does not manage or charge a markup then the markup funds will not be necessary. Similarly if the rebilling system 100 does not collect taxes then the tax fund will not be necessary.

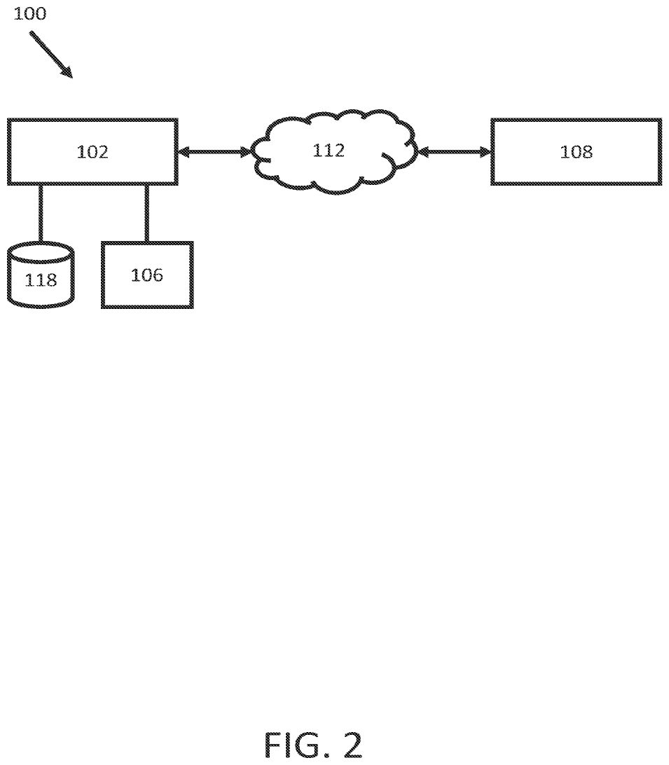

FIG. 2 depicts a block diagram of the rebilling system 100 of FIG. 1 interfacing with an issuer.

An Issuer 108 is an entity that creates virtual payment cards that will work with a given payment network (e.g. Visa or Mastercard).

In an embodiment the issuer 108 is a separate system and/or a separate party providing issuing services. That is, the issuer 108 is a third party that operates at a arms-length from the organization that owns or controls the rebilling system 100.

In some embodiments the issuer 108 includes an issuer server (not shown). The issuer server (or card issuer server or servers) is configured to issue and update the virtual payment cards that will work with a given payment network (e.g. Visa or Mastercard). It maintains a record in the Issuer Database with the Virtual Payment Card network details.

Similar to the rebilling server 100, the issuer server can be implemented on a network connected computer system or a virtual server on a cloud computing platform.

In some embodiments the issuer 108 further includes an Issuer Database (not shown). The issuer database is configured to store records related to the virtual payment card used to transact on the payment network. The data stored on the issuer database is similar to the virtual payment card data stored on the rebilling data store 118.

In other embodiments the issuer 108 and rebilling system 100 are controlled by the same organization. In this embodiment the rebilling system 100 and the issuer 108 is implemented on one or more servers controlled by the same party.

In this embodiment the rebilling system server 102 and issuer server reside on the same server. The rebilling system datastore 118 and the issuer database also reside on the same datastore. In other embodiments the rebilling system server 102 and the issuer server reside on different servers when the rebilling system 100 and the issuer 108 are controlled by the same organization.

It will be appreciated that the rebilling system 100, merchant, issuer, and payer communicate payment information over a payment network 112. The payment network 112 is a computer network over which payment requests and responses associated with the virtual card are transmitted between the Merchant and the Issuer.

This payment network 112 may include several layers of processing. These layers of processing may include, but are not limited to, point of sale (PoS) services, aggregator services, credit card networks, banking networks, etc. These services may communicate over the Internet or over private LAN and/or WAN networks. Examples of credit card payment networks include, but are not limited to, Visa, Mastercard, American Express, Discover, etc.

The payment network 112 includes organizations that are capable of mediating fund transfers between a party and another party, among other things. For instance, a payment network 112 is configured to mediate funds transfers between a merchant's account and a payer's (or buyer's) account for products or services provided by the Merchant to the Payer (or Buyer).

It will be appreciated that remittance processors on the payment network 112 will have one or more remittance processor servers (not shown). A remittance processor server (not shown) is a computer server or servers that connects to the payment network 112. It is configured to send and receive payment requests and responses over the payment network 112.

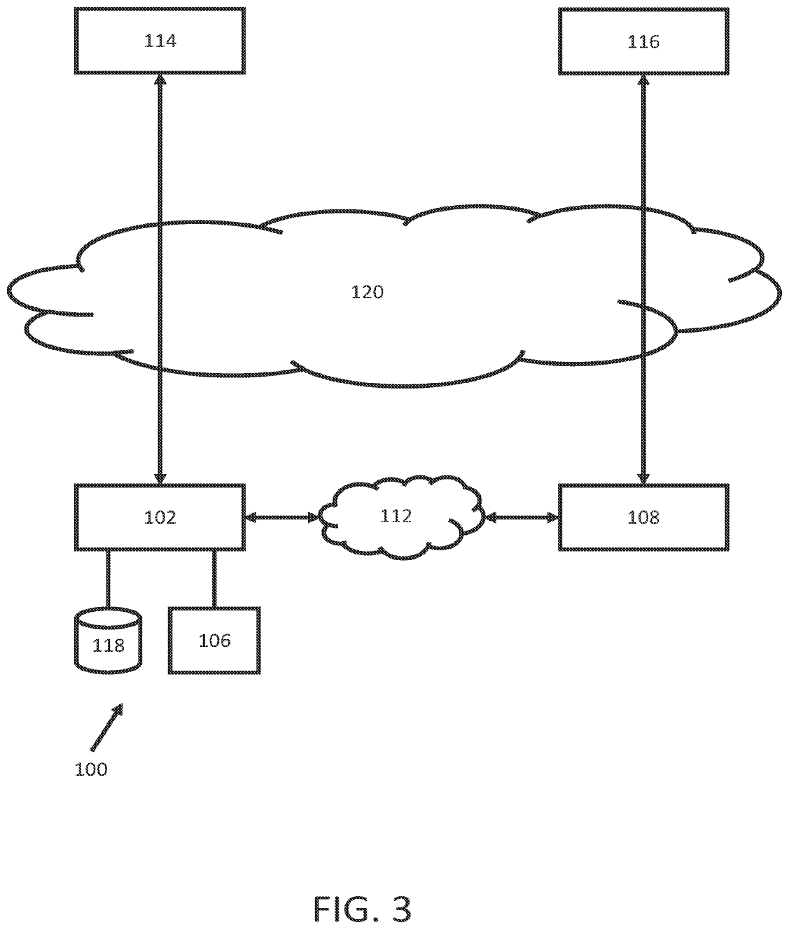

FIG. 3 depicts a block diagram of the rebilling system of FIG. 1 interfacing with an issuer, merchant, and a payer.

Referring now to FIG. 3, a payer 114 is depicted. A payer is a party whose payment source funds the transaction. That is, funds originating from the payer 114, at the end of the transaction, will be transferred to the merchant 116. As the transaction is processed, markups (or deductions) will be taken from the amount provided by the payer 114. That is, the final amount transferred to the merchant 116 may not be the same as the amount transferred from the payer 114.

For simplicity of depiction, a single payer 114 is represented throughout this patent. It will be appreciated by a person skilled in the art that there may be multiple payers associated with any given virtual payment card.

In an embodiment the payer 114 includes a payer system (not shown). The payer system includes a payer payment source server. The payer payment source server is configured to control a payer fund 412 among other things. In an embodiment the payment source server is a computer server (or servers) that send, receive, process and respond to requests for payment across a payment network.

The payer system also includes a Payer Fund 412. The Payer Fund 412 stores the payer's funds. Funds from the payer fund 412 will be transferred to the Settlement Fund 410 of the rebilling system 100 and vice versa.

This embodiment shows a computer network 120 between the Payer 114, the rebilling system 100, the issuer, and the merchant 116 through which the parties can communicate. It will be appreciated that the computer network 120 can be used to transmit payment requests and responses between the Payer's payment source and the rebilling system 100.

Referring again to FIG. 3, the system further includes a Merchant 116. The merchant sells the product and/or service to the buyer. In this embodiment the service is subscription merchandise.

In some embodiments the merchant 116 includes a merchant system (not shown).

The merchant system includes a Merchant billing system server (not shown). The merchant billing system server is a computer server (or servers) that sends, receives, processes and responds to payment requests over the payment network associated with the virtual payment card. The merchant billing system server is further configured to process the billing model of the subscription to generate charges. Furthermore, the Merchant Billing System Server controls access to the Merchant Fund 900.

The Merchant system also includes a Merchant Fund 900. The merchant fund 900 stores the merchant's funds. Funds from the merchant fund 900 will be transferred to the Float Fund 416 of the rebilling system 100 and vice versa.

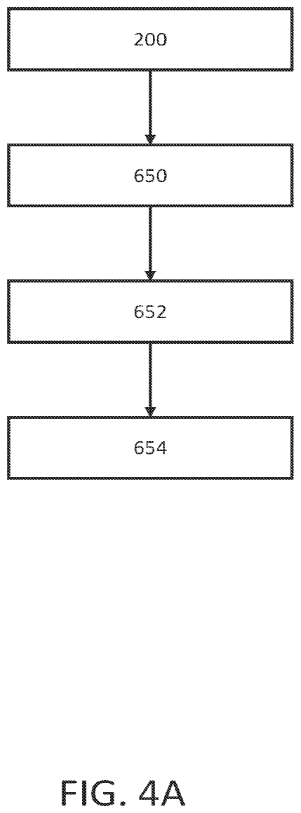

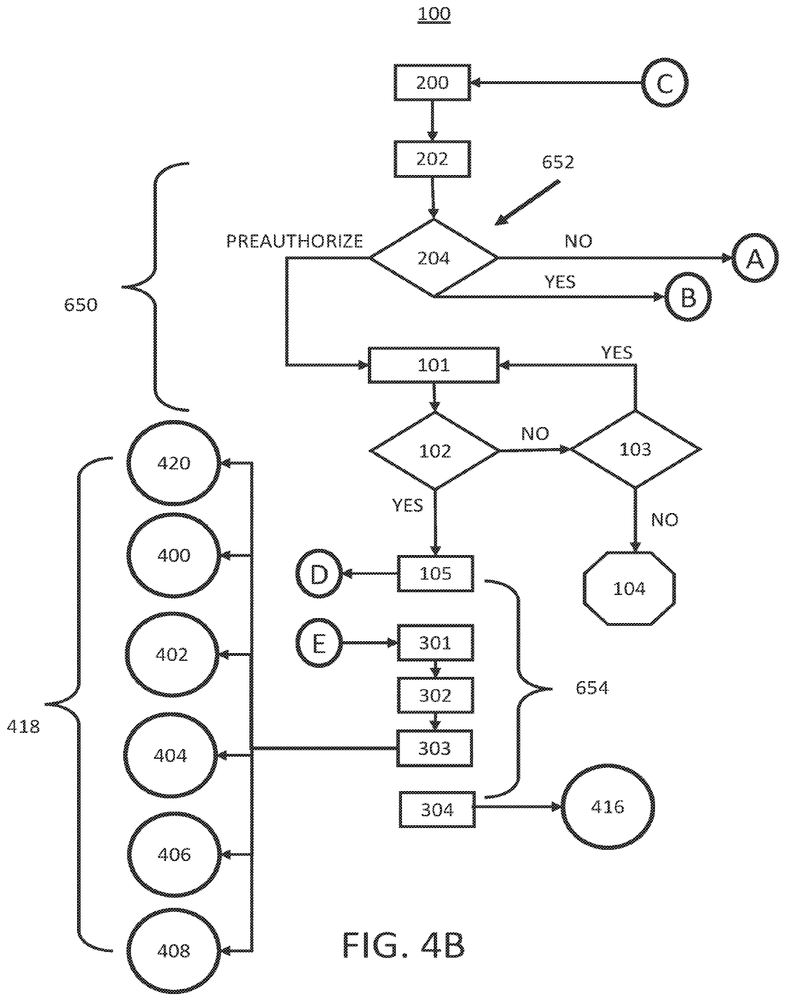

FIG. 4A depicts a method for rebilling. The method includes receiving a request for payment (or payment request, charge request, or charge) 200 from a merchant through a virtual payment card provided by a virtual payment card issuer 108. The request for payment 200 typically originates from a merchant—for instance, when a merchant charges a credit card (or virtual payment card, or virtual credit card).

Prior to using the rebilling system 100, the user must create or update a virtual payment card. A user of the rebilling system (such as a reseller, end-customer, or distributor) requests the creation or updating of a virtual payment card through a user interface or an application programming interface provided by the rebilling system 100. The rebilling system 100 creates or updates a virtual payment card through an Issuer 108.

Once created or updated, the virtual payment card information (that is, the basic information returned from the Issuer 108) and related rebilling system 100 specific data is stored in the rebilling system database 118. This information includes, but is not limited to:

Billing details. The information expected at point of sale by the merchant. This includes billing name, billing address, security code, card number, expiration date. The specific billing details will vary by policy of the payment network. In some embodiments, some billing details (e.g. the card number and security code) will be secret from the rebilling system and held only by the issuer; instead a reference token (e.g. a random string) will be returned by an issuer to identify the virtual payment card. This information is generally provided by the Issuer 108. The token is a shared secret representing the virtual credit card number and is generated by the issuer and shared with the rebilling system, wherein this allows the rebilling system to not store credit numbers and therefore avoid the commercial burden of PCI compliance.

Related parties. The parties related to transactions on the virtual card, such as the end customer, reseller, a distributor, or others as defined by policy. One or more such parties may be designated as the Owner of the virtual payment card in the rebilling system capable of configuring the virtual payment card. This information is provided to the rebilling system 100 by the user of the rebilling system 100.

Merchant ID. The ID the merchant uses to transact with the payment network. This information is either provided to the rebilling system 100 by the user of the rebilling system 100 or found via a lookup or from the charge requests forwarded from the payment network.

Underwriters. A list of parties who underwrite (that is, fund) each charge on the virtual payment card until the charge is eventually settled with a payer who reimburses the underwriter. The underwriter could be any mix of the rebilling system itself, a distributor, a marketplace, the reseller, or any other interested party. This information is provided to the rebilling system 100 by the user of the rebilling system 100.

Payment sources. A list of payment sources that will eventually fund the charge. The payment sources could belong to any mix of either the end customer, the reseller, an agent, a distributor, or any other party. This information is provided to the rebilling system 100 by the user of the rebilling system 100. It will be appreciated that multiple payment sources, including payment sources of multiple parties (e.g., end customer, reseller, agent, distributor, etc.) can be registered to a single virtual charge card through the rebilling system 100. Markup model. When a virtual payment card is created, a markup calculation is associated with the card to modify the initial charge request total. This information is provided to the rebilling system 100 by the user of the rebilling system 100.

An example of a markup model is as follows. If we let C be the initial charge request total, P be a percentage markup or discount, and F be a fixed price markup or discount, a markup formula of m=CP+F could be associated with the card along with values of P and F.

In some embodiments an ordered sequence of markup formulae can be associated with the card. This ordered sequence defines fees and/or amounts for the: Reseller, Distributor, Sales, Usage, Value Added or other Taxes, Transaction Fees; and Fees for use of the rebilling system 100 itself. In this embodiment a running subtotal of markups is tallied.

If a markup is meant to be a surcharge, if we let S be the subtotal of markup formulae applied so far, a markup formula could be alternatively defined as m=SP+F.

This markup model will create a sequence of markups (m) and parties (p) receiving the markup, [(m1, p1), (m2, p2), (m3, p3), . . . , (mn, pn)] tracking which parties are owed which markups, as well as the total charge, T=C+Σm for all m, which will be passed onto the end customer.

Furthermore, in some embodiments additional policies can be attached to control when a markup formula may be applied. Examples include, but are not limited to, a time-expiry (e.g. for a 90-day discount) or a threshold (e.g. provide discounts at higher price tiers) or a risk profile (e.g. increase markup fees with increased payment source failures).

Control rules. The virtual payment card may have additional business logic rules to control spending set by any mix of the end customer, the rebilling customer, the reseller, the underwriter, or other interested party. This information is provided to the rebilling system 100 by the user of the rebilling system 100.

Examples of control rules include, but are not limited to:

Maximum charge amounts. The maximum amount of money a single charge request may have.

Maximum credit. The maximum amount the underwriter will credit this card individually or in aggregate the owner or the end customer from the underwriter's fund.

Predicted charge amounts. A predictive model of what charge amounts should be, such as but not excluded to a simple minimum/maximum range; known pricing tiers; or a maximum allowed change between subsequent charges.

Limited use card. The card can only be charged once or a fixed number of times before automatically being deactivated to prevent recurring transactions.

Consolidated payment. A payer may not accept charges directly, but delegate charges to another payer who will aggregate charges and periodically charge the sum total to the first, delegating payer.

Once the virtual payment card is configured in the rebilling system 100 the virtual payment card can be used.

Once the merchant charges the virtual payment card, the payment request 200 is sent via the payment network 112. Typically the payment request 200 will go to a remittance processor (for instance, the Issuer) for processing.

In this embodiment, however, the Issuer 108 will forward the payment request 200 to the rebilling system 100 without processing or otherwise altering the request. That is, the rebilling system 100 is the remittance processor.

Once the rebilling system 100 receives the payment request 200, the payment request 200 is processed 650 by the rebilling system. The step of processing 650 includes any processes and/or verifications that are required to verify, validate, process, and otherwise fulfill the payment request. These processes and/or verifications include, but are not limited to: validating payment card details such as the payment card number, expiration date, billing address, billing postal/zip code, billing name, and/or confirmation code; determining whether there are sufficient funds in the accounts to fulfill the payment request 650; determining whether there are any outstanding instructions that would affect the payment request 650 (e.g., hold payment, pay partially, etc.); determining whether the accounts holding the funds are in arrears or in collection; whether the payer 114 (or end-customer) has cancelled the subscription; whether a refund or chargeback against the merchant 116 (or SaaS App provider) are pending; and any other business rules that are required to fulfill the payment request 200.

Once processing 650 has commenced, the rebilling system 100 authorizes 602 the payment request 200 if certain criteria are met. Authorizing 602 the payment request 200 will, among other things, return a corresponding authorization (or authorization message) to the payment request 200 indicating that the payment request 200 has been authorized.

In an embodiment the authorization message is sent to the issuer 108. The issuer 108 is then responsible for transmitting the authorization to the merchant 116 via the payment network 112.

In another embodiment the authorization message is sent directly to the merchant 116 via the payment network 112.

In scenarios where the payment request 200 is not authorized by the rebilling system 100, the rebilling system 100 will send a declined message corresponding to the payment request 200. The declined message indicates that the payment request 200 has been denied.

In a manner similar to the authorization message, in an embodiment the declined message is sent to the issuer 108. The issuer 108 is then responsible for transmitting the declined message to the merchant 116 via the payment network 112. In other embodiments the declined message is sent directly to the merchant 116 via the payment network 112 rather than passing through the issuer 108.

It will be appreciated that the criteria for determining whether a payment request 200 is authorized will depend on, among other things, the virtual payment card information, availability of funds, and the rules and requirements of the rebilling system 100.

An example authorization 602 flow is as follows. The rebilling system 100 validates the correctness of the virtual card data (e.g., card number, expiration date, billing address, CCV number, etc.) contained in the payment request 200. The rebilling system 100 also determines whether the payment request 200 is from a permitted (or registered) merchant. The rebilling system 100 also determines whether there are sufficient resources in the funds (whether controlled by the rebilling system 100 or the payer 114) to fulfill the payment request 200. Once any one or all of these conditions are met (depending on the requirements of the implementation), the rebilling system 100 sends an authorized message to the issuer 108 (or merchant 116) corresponding to the payment request 200 via the payment network 112.

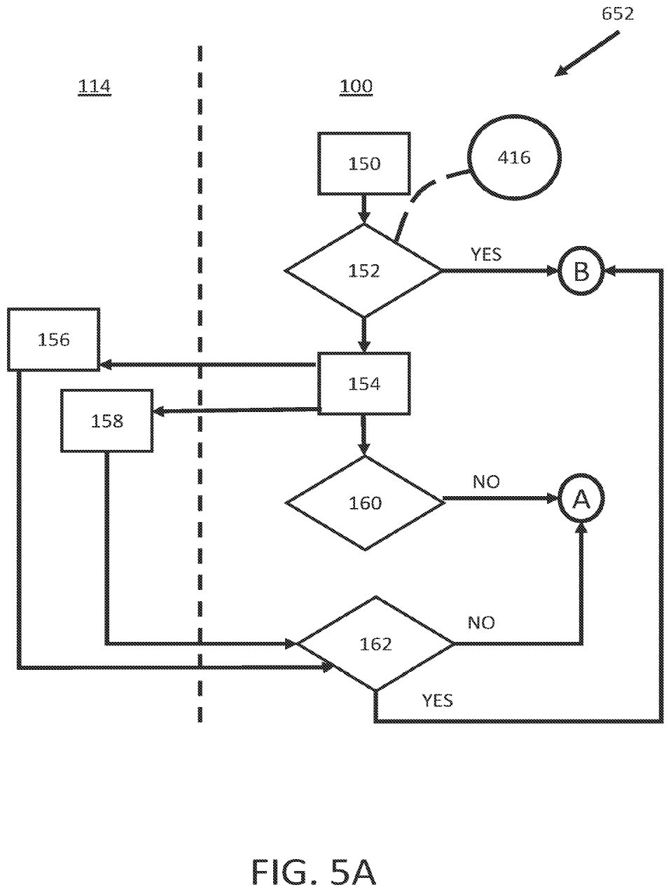

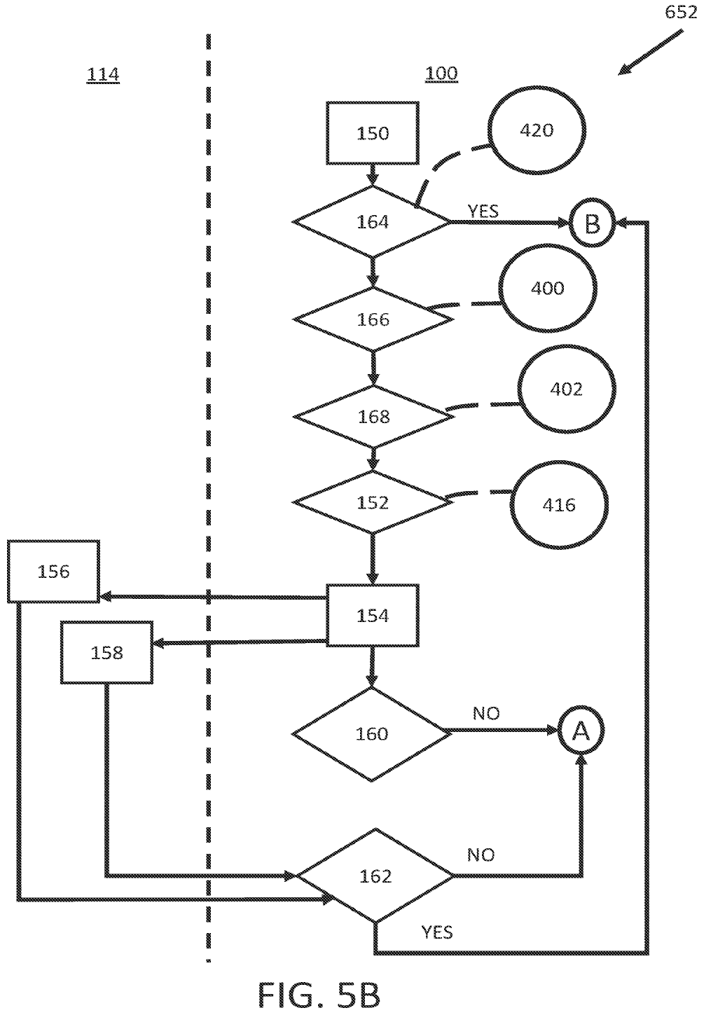

Other example authorization 602 flow scenarios are disclosed in FIG. 5A and FIG. 5B.

It will be appreciated that in some embodiments not every condition must be met before an authorization message is sent to the issuer 108 (or merchant 116). For instance, in some embodiments it is not necessary to determine whether sufficient funds are available prior to sending the authorization request. This is useful in scenarios where the rebilling system 100 offers a temporary line of credit to the payer 114, for example.

It will also be appreciated that the order in which the rebilling system 100 validates the payment request 200 does not matter. In some embodiments it may be preferable to validate several rules concurrently. In other scenarios it may be preferable to validate the payment request 200 one criteria at a time.

Once the rebilling system 100 has authorized 652 the payment request 200, the rebilling system transfers 654 funds from the various accounts to fulfill the payment request 200.

These funds can be transferred from: a payer fund 412 to a rebilling system 100 controlled fund; from an account controlled by the rebilling system 100 to a merchant account; between funds controlled by the rebilling system 100; or from a rebilling system-controlled account 418 to an account controlled by a third-party.

Once the funds are transferred from the rebilling system 100 to the merchant 116 the payment request 200 is considered fulfilled.

It will be appreciated that a rebilling system-controlled fund 418 is a fund that can be manipulated by the rebilling system 100. That is, the rebilling system 100 is capable of withdrawing and depositing funds into these accounts, either on behalf of the billing system 100 or on behalf of some other party. That is, these accounts, though controllable by the rebilling system 100, may not be owned by the rebilling system 100. The rebilling system 100 may be managing these funds on behalf of third parties such as resellers, distributors, merchants, payers, or any other party that has an interest in the transaction. In some embodiments the third parties will have given advanced authorization to the rebilling system 100 to manage these funds on their behalf. In other embodiments the rebilling system 100 may need to seek permission from the third party before performing at least some transactions on the third-party owned account.

Referring now to FIG. 4B, an alternate method for rebilling is depicted. Once the payment request 200 is received the rebilling system 100 calculates the total charge 202. The total charge is the sum of the amount requested in the payment request 200 and a markup added by the rebilling system 100.

It will be appreciated that in many scenarios the amount charged to the payer 114 by the rebilling system 100 will not be the same as the amount requested by the merchant 116 in the payment request 200. This difference is considered the markup. The markup is added by the rebilling system 100 to account for, among other things, a reseller's taxes, commissions, discounts, transfer and/or transaction fees, exchange rate differences, distributor fees, processing fees, reseller's fees, and any other fees associated with the resale of products and/or services.

Adding the markup at the rebilling system 100 rather than at the merchant 116 has advantages. For instance, by working with the rebilling system 100 the merchant 116 can decouple how the merchant 116 is paid from a specific remittance processor or payment network 112. This allows the merchant to abstract away the forms of payment accepted by the merchant 116. That is, the merchant 116 can accept any method of payment supported by the rebilling system 100.

Furthermore, the rebilling system 100 allows merchants 116 to support resellers and distributors of their product and/or service without having to implement a markup or commission system of their own. That is, the rebilling system 100 provides merchants 116 selling subscription merchandise (for example) a way to enable resale of their subscriptions without modification of their existing billing system or creation of a separate billing system. This is because the rebilling system 100 is directly compatible with the existing payment card networks 112 (e.g. Visa, Mastercard) the merchant's 116 billing system uses.

The rebilling system 100 also allows merchants 116 to support multiple intermediaries to act as a distribution chain to resell subscriptions. The rebilling system 100 does this by attaching each intermediary to the virtual payment card and automating each intermediary's mark ups, fees, discounts, sales taxes, spending controls, and other obligations and controls.

Referring again to FIG. 4B, once the total charge 202 is computed (i.e., markups added to the payment request 200), the rebilling system 100 determines whether to authorize 204 the transaction (as was described in FIG. 4A).

In the embodiment depicted in FIG. 4B the payer 114 has the option to pre-authorize the total charge 202 (and payment request 200) before the payment request 200 is received. That is, the payer 114 has the option to bypass the rebilling system's 100 authorization 204 mechanism. In the scenario where the total charge 202 (and payment request 200) is pre-authorized the authorization 204 mechanism is bypassed. The rebilling system 100 sends an authorized message and the funds are transferred from a rebilling system-controlled fund (e.g., a Float Fund 416) to the Merchant 116 before requesting funds from the payer 114.

Once the total charge 202 (and payment request 200) is pre-authorized (or authorized 204), the rebilling system 100 determines whether there are sufficient funds to pay the total charge 202 (and payment request 200). The rebilling system 100 does this by charging 101 each payer-controlled payment source until the amount of the total charge 202 (and payment request 200) is recovered.

In some embodiments the payer 114 registers one or more payer-controlled payment sources with the rebilling system 100. These payer-controlled payment sources are used to provide funds to the rebilling system 100 for settling the total charge 202 (and payment request 200). Payer-controlled payment sources include, but are not limited to, checking/debit/savings accounts, credit cards, lines of credit, ACH accounts, money orders, etc.

In some embodiments the payer 114 must actively authorize 102 any transactions involving payer-controlled payment sources prior to the rebilling system 100 withdrawing funds from the payer-controlled payment source. For instance, in the embodiment depicted in FIG. 4B the rebilling system 100 will send an authorization request to a payer system or payer 114 to seek authorization 102 to withdraw funds from the payer-controlled payment source.

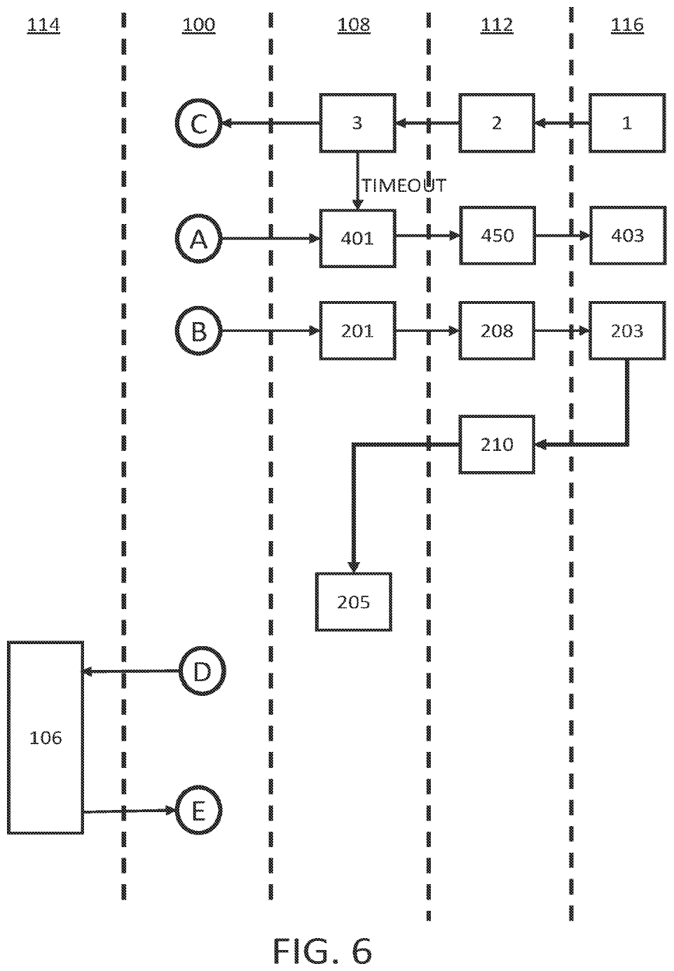

Once the payer 114 authorizes 102 the charge the rebilling system 100 captures 105 the amount in the authorized transaction. The funds are then transferred 130 from a payer-controlled payment source to a rebilling system-controlled fund 418 (see FIG. 6 D).

In another embodiment the payer 114 (or payer system) pre-authorizes the rebilling system 100 to withdraw funds from the payer-controlled payment source without requesting further authorization from the payer 114. In this embodiment the rebilling system 100 will automatically attempt to withdraw funds from the payer-controlled payment source without seeking further authorization from the payer 114. The rebilling system 100 will not check whether the payer-controlled payment source has sufficient funds prior to withdrawing the funds from the payer-controlled payment source.

In the scenario where the payer 114 (or payer system) declines the authorization 102 request (in the case of active authorization), the rebilling system 100 will attempt to obtain funding 103 from another payer-controlled payment source that is registered with the rebilling system 100.

In the scenario where the payer-controlled payment source has insufficient funds, the rebilling system 100 can either attempt to obtain funding from another payment source without withdrawing funds from the payer-controlled payment source or withdraw what funds it can from the payer-controlled payment source before attempting to obtain funding from another payer-controlled payment source (including those payment sources controlled by another payer). That is, the rebilling system 100 can obtain a partial payment of the total charge 202 (and payment request 200) from a payer-controlled payment source before attempting to obtain funds from another payer-controlled payment source (or from another payment source controlled by another payer).

If no other payment sources are available then the rebilling system 100 will begin the Dunning (or collections) process 104 to recoup the amount that was transferred to the Merchant 116 earlier in the process on behalf of the payer 114.

Once the rebilling system 100 has partially or fully received 301 the funds from the payer-controlled payment source(s) the rebilling system 100 then settles 302 the partially or fully received 301 funds. That is, the partially or fully received 301 funds are transferred 303 to various merchant-controlled funds, rebilling-system controlled funds, and/or third-party funds to settle the transaction.

In an embodiment the partially or fully received 301 funds are temporarily placed in a rebilling system-controlled settlement fund 410 from which other rebilling system-controlled funds (such as the float fund 416) will be reimbursed 304.

If the rebilling system 100 transferred funds from the float fund 416 to the merchant 116 on behalf of the payer 114 earlier in the process, the rebilling system 100 will reimburse 304 the float fund 416. Typically the amount reimbursed from the settlement fund 410 to the float fund 416 will not exceed the amount in the payment request 200. That is, the rebilling system 100 will reimburse, from the settlement fund 410 to the float fund 416 the exact amount transferred to the merchant, which is typically the amount in the payment request 200.

The remaining funds are then distributed amongst one or more markup funds. These markup funds are held on behalf of resellers, distributors, the rebilling system 100, or other third parties (such as the government, a national revenue service, etc.).

It will be appreciated that the remaining funds are those funds that remain after the float fund 416 is reimbursed. In most cases these remaining funds would be equal to the difference between the total charge 202 and the amount of the payment request 200 (i.e., the markup). These remaining funds are then distributed to one or more funds that are held by the rebilling system 100 on behalf of resellers, distributors, the rebilling system, or other third parties.

Examples of other funds include: a reseller markup fund that is used to remunerate resellers of the merchant's product or services; a distributor markup fund that is used to remunerate distributors of the merchant's product or services; a tax fund for withholding sales taxes associated with the resale or distribution of the merchant's product or services; a fees fund for recovering any transactional fees associated with, among other things, the transfer of funds from one account to another; and other parties' fund 406 for capturing any funds due to a third party (e.g., broker fees, finders fees, commissions, etc.).

FIG. 5A depicts an embodiment authorization logic for the method of FIG. 4A and FIG. 4B. Specifically this describes the authorization 652 step. In this embodiment, the authorization flow of FIG. 5A is used to determine whether to authorize 204 the total charge 202.

In this embodiment once the authorization logic 150 is initiated the rebilling system 100 determines 152 whether there are sufficient funds in the float fund 416 that can be applied to the total charge 202 (and payment request 200).

The float fund 416 is a rebilling system-controlled fund used to pay merchants 116. It can be considered an intermediary fund. That is, it is used to temporarily hold funds that are to be transferred to merchants 116 or other parties.

In some embodiments the float fund 416 may be self-financed. That is, any funds in the float fund 416 must be obtained from other rebilling system-controlled funds. In other embodiments the float fund 416 has a credit extended to it so that it can pay merchants 116 with funds borrowed on a short-term basis (e.g., loans from a bank, payment network, or financial institution, etc.).

If the rebilling system 100 determines 152 that there are sufficient funds in the float fund 416 that can be applied to the total charge 202 (i.e., the markup and the amount in the payment request 200) then the total charge 202 is authorized. The rebilling system 100 then proceeds with transferring 654 funds between the various merchant 116, payer 114, and rebilling system-controlled funds 418.

If the rebilling system 100 determines 152 that there are insufficient funds in the float fund 416, then the rebilling system 100 checks other payment sources 154 for fund availability. These other payment sources 154 include, but are not limited to, accounts held on behalf of the payer 114 on the rebilling system 100 or rebilling system-controlled accounts including, but not limited to, reserve cash funds, trust funds, or any other account that can be legally drawn upon to fulfill the total charge 202 (that includes the amount in the payment request 200).

In some scenarios the rebilling system 100 must seek authorization from the payer 114 prior to utilizing funds controlled by the payer 114. For instance, this scenario may arise when the rebilling server-controlled funds do not contain sufficient funds to fulfill the total charge 202 (that includes the amount in the payment request 200). In these scenarios the rebilling system 100 is configured to send an authorization request 156 to the payer 114 requesting authorization to draw funds from a payer account to fulfill the total charge 202 (and the amount in the payment request 200). In this embodiment the rebilling system 100 is also configured to send an authorization request 158 to the reseller requesting authorization to draw funds from a reseller's account to fulfill the total charge 202 (and the amount in the payment request 200).

If the request to the payer 114 (or reseller) is approved then the rebilling system 100 authorizes 162 the total charge 202 (and the amount in the payment request 200) and the rebilling system 100 proceeds with transferring 654 funds between the various merchant 116, payer 114, and rebilling system-controlled funds.

If, however, the payer 114 does not authorize 162 the charge, or if the payer authorization request times out 160, then the authorization request is declined. The rebilling system 100 then sends a declined message to the issuer 108 (or merchant 116, depending on the implementation) notifying them that the payment request 200 has been declined.

FIG. 5B depicts an alternate embodiment authorization logic for the method of FIG. 4A and FIG. 4B. The authorization logic of FIG. 5B is similar to FIG. 5A. However, prior to checking 152 the float fund 416 and payer 114 funds for sufficient funds, the rebilling system 100 also checks several other funds to determine whether the total charge 202 (including the amount in the payment request 200) can be authorized.

These other funds include, but are not limited to, a customer fund 420, a reseller fund 400, and a distributor fund 402. It will be appreciated that these funds are held by the rebilling system 100 for the benefit of customers, resellers, and distributors respectively. The rebilling system 100 can also control these funds if prior authorization has been provided by the customer, reseller, and/or distributor respectively.

In this scenario the customer, reseller, and/or distributor provides pre-authorization to the rebilling system 100 for any future total charge 202 and payment requests 200. This pre-authorization is obtained in advance of the payment requests 200 (and total charge 202) so that the rebilling system 100 can authorize these charges without continually seeking approval from the customer, reseller, and/or distributor respectively.

The rebilling system then determines whether there are sufficient funds in any one or a combination of the available funds. The rebilling system does this by checking 164 the customer fund 420, checking 166 the reseller fund 400, checking 168 the distributor fund 402, and checking 152 the float fund 416 to determine whether there are sufficient funds in any one or a combination of the funds to cover the total charge 202 (including the amount in the payment request 200). If there are sufficient funds in any one or a combination of the funds, then the rebilling system 100 authorizes the total charge 202 (including the amount in the payment request 200). If there are insufficient funds in all of the funds then the total charge 202 (including the payment request 200) is declined.

FIG. 6 depicts an alternate embodiment method for rebilling using the rebilling system 100. This method depicts the method of FIG. 4B and its interactions with the payer 114, issuer 108, payment network 112, and merchant 116.

In this embodiment the Issuer 108 (that is, the virtual card issuer) delegates the billing processing to the rebilling system 100 once it receives a payment (or charge) request 001 from the merchant 116. The Issuer's 108 role is to provide an interface (i.e., the virtual payment card issued by the Issuer 108) between the merchant 116 and the rebilling system 100 via a payment network 112. That is, it is an intermediary between the rebilling system 100 and the merchant 116.

Note that in this embodiment the Issuer 108 performs minimal to no processing of the payment request 001 from the merchant 116 once it is received through the payment network 112. That is, the Issuer 108 delegates 003 the payment request once the charge request 001 is transmitted 002 through the payment network 112 and received by the issuer 108.

Once the charge request 001 is received at the rebilling system 100 the request is processed using the method as disclosed in FIG. 4B.

If the payment request 001 is authorized by the rebilling system 100, the rebilling system 100 will send an authorization to the issuer 108. This authorization 201 is then transmitted 208 through the payment network 112 to the merchant 116.

Once the merchant 116 receives the authorization 202 from the issuer 108 (via the payment network 112) the merchant 116 proceeds to capture the funds 203. In this embodiment the merchant 116 transmits 210 a funds capture request to the issuer 108 via the payment network 112. Once the issuer 108 receives the funds capture request the issuer 108 will send a request to the rebilling system 100 to transfer 205 funds from the rebilling system-controlled float fund 416 to a merchant-controlled fund (or merchant fund 900)

Once the funds have been transferred 205 from the rebilling system-controlled float fund 416 to the merchant fund 900 the payment transaction between the rebilling system 100 and the merchant 116 is considered completed.

If the payment request 001 is declined by the rebilling system 100, the issuer 108 transmits 450 a decline message 401 via the payment network 112 to the merchant 116. Once the merchant 116 receives the payment declined 403 the method ends. In these scenarios the merchant 116 can re-attempt the charge or proceed with other processes that are outside the scope of this disclosure to try and recover payment for products and/or services provided.

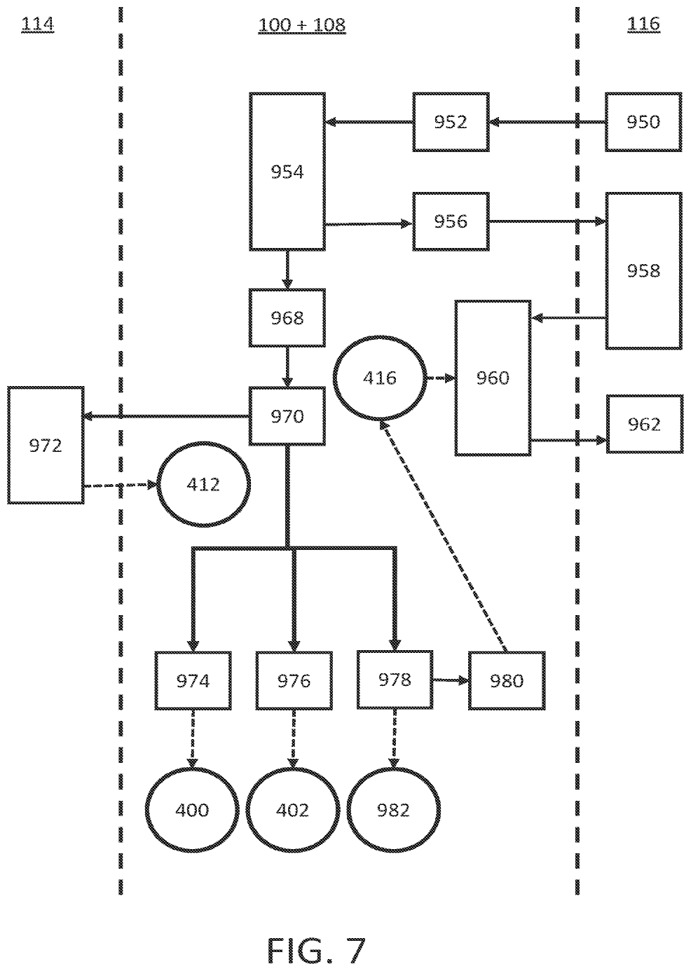

FIG. 7 depicts an alternate method for rebilling that for a system that is tightly integrated with a virtual card issuer and payment platform. In this embodiment the rebilling system 100 is combined with a known virtual card issuer and payment platform. Examples of known virtual card issuer and payment platforms include, but are not limited to, MARQETA.

In this embodiment the rebilling system 100 utilizes application programming interfaces (APIs) published by MARQETA to process transaction requests from merchants 116. In this embodiment the merchant 116 is a software-as-a-service (SaaS) application.

The SaaS application first initiates a payment request 950 on a virtual payment card issued by MARQUETA. The payment request 950 is sent to MARQUETA which then forwards 952 the request to the rebilling system 100 for processing. That is, MARQUETA delegates processing to the rebilling system 100.

Once the charge request 950 is received at the rebilling system 100, the rebilling system 100 approves the payment and initiates the asynchronous funding process 954. That is, the rebilling system 100 approves the charge before collecting (or recovering) funds from the customer payment sources. This effectively serves as a credit extension (or short-term loan) by the rebilling system 100 to the payer 114.

Once the rebilling system 100 approves 954 the payment request, an approved message 956 is sent to the merchant 116 (or SaaS App) through MARQETA indicating that the charge request has been approved. The merchant 116 (or SaaS App) can then begin the capture request 958 through MARQETA to collect the funds that have been approved.

Once the rebilling system 100 approves the payment request, the amount initiated on the virtual card is then deducted 960 from a program funding source (or float fund 416). The deducted funds are transferred from the rebilling system-controlled program funding source (or float fund) to the merchant fund 900. The Merchant receives payment 962.

This completes the payment from the perspective of the merchant 116 (or SaaS app). In this embodiment the funds are transferred from a rebilling system-controlled Program Funding Source (or float fund 416). This program funding source is effectively a float fund 416 that contains funds that can be used to complete transactions on behalf of the payer 114 (or customer).

While the funds are transferred to the SaaS app the rebilling system 100 proceeds to collect the total charge 202 (that includes the amount in the payment request 950) from the payer 114 (or customer).

As was discussed in FIG. 4A and FIG. 4B, the rebilling system 100 calculates 968 the fees and markups that will be added to the payment request 950 to make up the total charge 202. The total charge 202 is then recovered from the payer-controlled payment source. In this embodiment the payer 114 (or customer) has given permission to the rebilling system 100 to bill 970 and transfer 972 funds from the payer's (or customer's) payment source without having to obtain authorization for each billing request. In this scenario the rebilling system 100 uses a MARQETA API to bill and transfer funds from the payer's (or customer's) payment source.

In this embodiment funds from the payer's (or customer's) payment source is transferred to a Customer-owned general purpose Account (or Customer GPA) that is controlled by the rebilling system 100. An example of a customer GPA would be the payer fund 412, but it will be appreciated that it can be any customer owned but rebilling system-controlled fund.

In this embodiment the rebilling system 100 is authorized to transfer funds into and out of the Customer GPA. The total charge 202 is transferred to the Customer GPA from the payer's (or customer's) payment source.

This total charge 202 is then distributed amongst the various funds. The various markups (i.e., the difference between the total charge 202 and the payment request 950) are distributed amongst the various markup general purpose accounts (GPA). In this embodiment each of the reseller, distributor, and rebilling system 100 are each entitled to a portion of the markup. These markups include, but are not limited to, fees for services rendered to the payer (customer) and/or merchant (e.g., resellers markups), convenience fees, transfer fees, interest, regulatory fees (access fees, environmental fees, recovery fees, etc), and/or government fees (taxes).

The respective fees are transferred to each of their respective GPAs. In this embodiment a portion of the funds are: transferred 974 to the reseller's fund 400; transferred 976 to the distributor's fund 402; and transferred 978 to the rebilling system's general purpose account (or fund) 982.

In this embodiment since the rebilling system 100 paid the merchant 116 (or SaaS app) before collecting the funds from the payer 114 (or customer), the payment request 950 is also transferred 978 to the rebilling system's GPA 982 in addition to any markup owed to the rebilling system 100. In this way the rebilling system 100 recovers the payment it made in advance to the merchant 116 (or SaaS App).

In this embodiment the rebilling system 100 then replenishes the program funding source (or float fund 416) by transferring 980 funds from the rebilling system's GPA 982 to the program funding source (or float fund 416). This amount can then be used to fulfill other payment requests that come in from merchants 116 (or SaaS Apps).

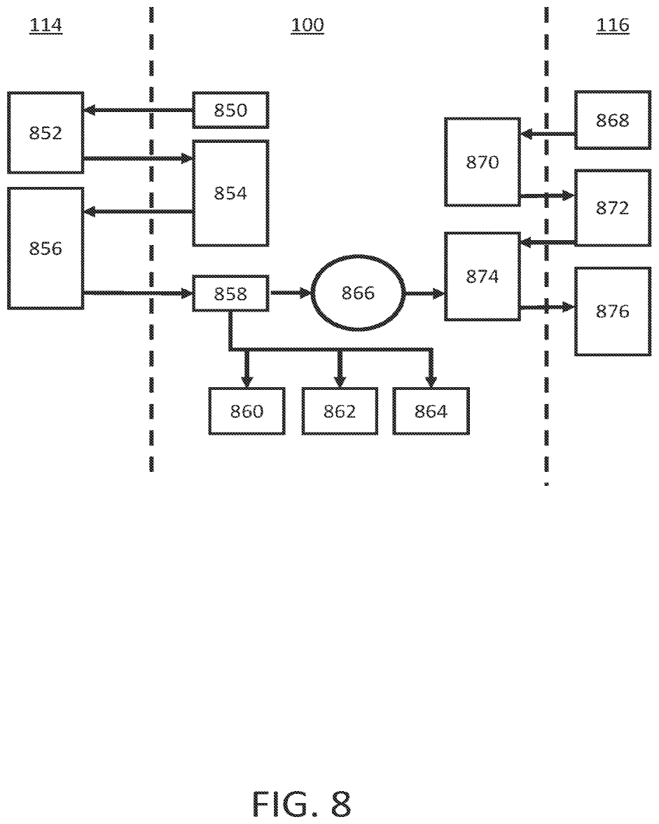

FIG. 8 depicts a method for bundle rebilling.

In this embodiment the rebilling system 100 is configured to transfer funds from the payer 114 (or customer) for the bundle of subscription services being used by the payer 114 (or customer) prior to the merchant 116 (or SaaS app) initiating a payment request on a virtual payment card.

In this embodiment the rebilling system 100 first initiates a bundle billing request 850 to the payer 114 (or customer). The bundle billing request 850 includes the total charge 202 information for each of the payer's 114 (or customer's) multiple subscribed services. So, by way of example, if the payer 114 (or customer) subscribes to a hosting service, an ad network service, a remote data storage service, and an online marketing service then the rebilling system 100 would request the combination of the total charges 202, including markup, for all of the subscribed services.

The payer 114 (or customer) then approves the payment request by authorizing 852 the request. Once the rebilling system 100 receives the authorization 854, the rebilling system 100 submits a capture request 856 to the payer 114 (or customer).

Once the payer 114 (or customer) receives the capture request 856, the payer 114 (or customer) completes the transaction by transferring the funds to the rebilling system 100.

The rebilling system 100 then distributes 858 the funds transferred from the payer 114 (or customer) to each of the markup fund accounts. In this embodiment the total charge 202 includes a markup fee to the rebilling system 100, a markup fee to the reseller, and a markup fee to the distributor. These fees are transferred to the rebilling system's account 860, the reseller's account 862, and the distributor's account 864 respectively.

The remaining funds after the markup is disbursed are transferred to a holding account 866. This holding account 866 is used to fund payment requests from the merchant 116 (or SaaS application) once the merchant 116 initiates 868 a payment request on the virtual payment card issued by the issuer.

In this embodiment the merchant 116 (or SaaS application) initiates 868 a payment request on the virtual payment card. In this embodiment the rebilling system 100 is also the issuer 108. That is, the payment request 868 passes through the payment network 112 directly to the rebilling system 100 where the payment request 868 is processed.

Since the funds for paying the payment request have already been captured from the payer 114 (or customer), the rebilling system 100 returns an authorization 870 for the payment request. Prior to receiving the merchant's payment request 868 the funds captured from the payer 114 (or customer) are stored in the holding account 866.

Once the merchant 116 (or SaaS app) receives the authorization 870 from the rebilling system 100 the merchant 116 (or SaaS app) begins the funds capture request 872. Once the rebilling system 100 receives the funds capture request 872 from the merchant 116 (or SaaS app) the funds are transferred 874 from the holding account to the merchant 116 (or SaaS app). Once the funds are received 876 at the merchant-controlled account the transaction is completed.

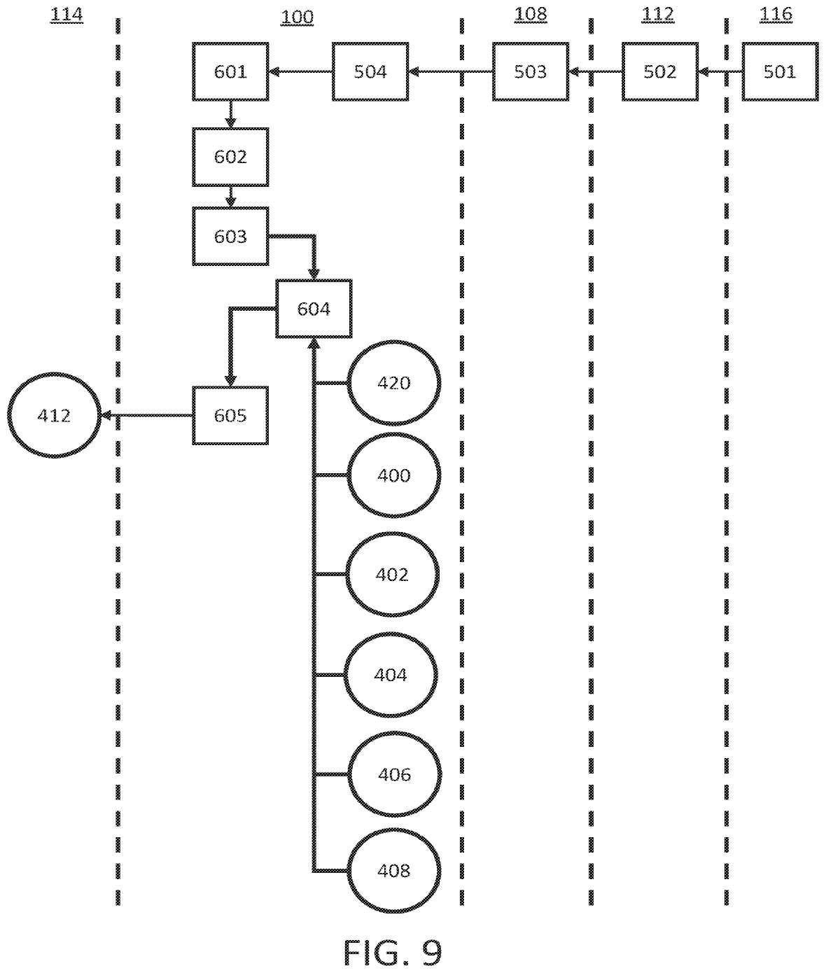

FIG. 9 depicts a method for processing refunds using the rebilling system 100. When a merchant refunds (either fully or partially) a charge on a virtual payment card, that refund must be routed and settled by the rebilling system 100. The refund must also account for returning markups, sales taxes, fees, and other refund policies configured in the rebilling system 100.

In this embodiment once a payer 114 requests a refund directly with the merchant 116 the merchant 116 initiates a Refund charge 501. The refund charge 501 is a full or partial refund of a previous charge.

Once the refund charge 501 is initiated it is transmitted 502 over the payment network 112 to the issuer 108.

In this embodiment the issuer 108 delegates any transactions associated with this virtual payment card to the rebilling system 100.

Once the issuer 108 receives the refund request from the payment network 502 the issuer transfers 503 the refunded funds from the merchant's payment source (or bank account) to the rebilling system-controlled Float Fund 416.

Once the funds have been returned to the rebilling system-controlled float fund 416 the issuer 108 sends a notification 504 to the rebilling system 100 that the refund has been transferred.

The rebilling system 100 then initiates the refund process. The rebilling system first retrieves 601 the charge record to determine which accounts (funds) need to contribute to the refund. The rebilling system 100 retrieves the transaction history for the charge from the database. The transaction history contains information regarding the markups that were applied during the rebilling that must now be refunded to the payer 114 (or customer).

This is done because the rebilling system 100 must account for the difference between the total charge 202 and the requested amount 200 from the merchant in order to complete the refund to the payer (or customer). Included in this step is looking up the markups 603. This retrieves the markup amounts and associated parties from the charge request records to prepare to the refunds.

Since the merchant 116 has already transferred the funds to the float fund, the rebilling system 100 refunds the float 602 in its records accordingly. In some embodiments the the charge request is updated to indicate whether the refund was a full or partial refund.

The rebilling system 100 then refunds markups 604. The rebilling system 100 calculates amounts to refund the markups. These calculated amounts are proportional to the refunded amount/initial charge request amount and depend on whether the refund was a full or partial refund. The markups, similar to the rebilling process, include, but are not limited to, the reseller markup, the distributor markup, taxes, other markups, and fees.

It will be appreciated that some markups may be non-refundable. These non-refundable markups will be excluded from the refund calculation. Examples of such non-refundable fees include, but are not limited to bank transfer fees, exchange rate differences, etc.

Once the rebilling system 100 calculates the refund amounts, the rebilling system 100 then initiates refunds from the Funds associated with each markup.

If insufficient funds are available in the markup's Fund, funds will be drawn from the rebilling system-controlled Float Fund to fund the refund. The associated markup fund is then marked in arrears. If the markup fund is in arrears past a predefined threshold then a dunning (or collections) flow is initiated against the party associated with the markup fund.

Once the refund amount has been collected the rebilling system 100 refunds 605 the payer. For a full refund the amount that was initially requested (i.e., the total charge 202) is returned to the payer's (or customer's) payment source (or account) minus any non-refundable fees (if any). For partial refunds a partial amount is returned to the payer's (or customer's) payment source (or account) minus any non-refundable fees (if any).

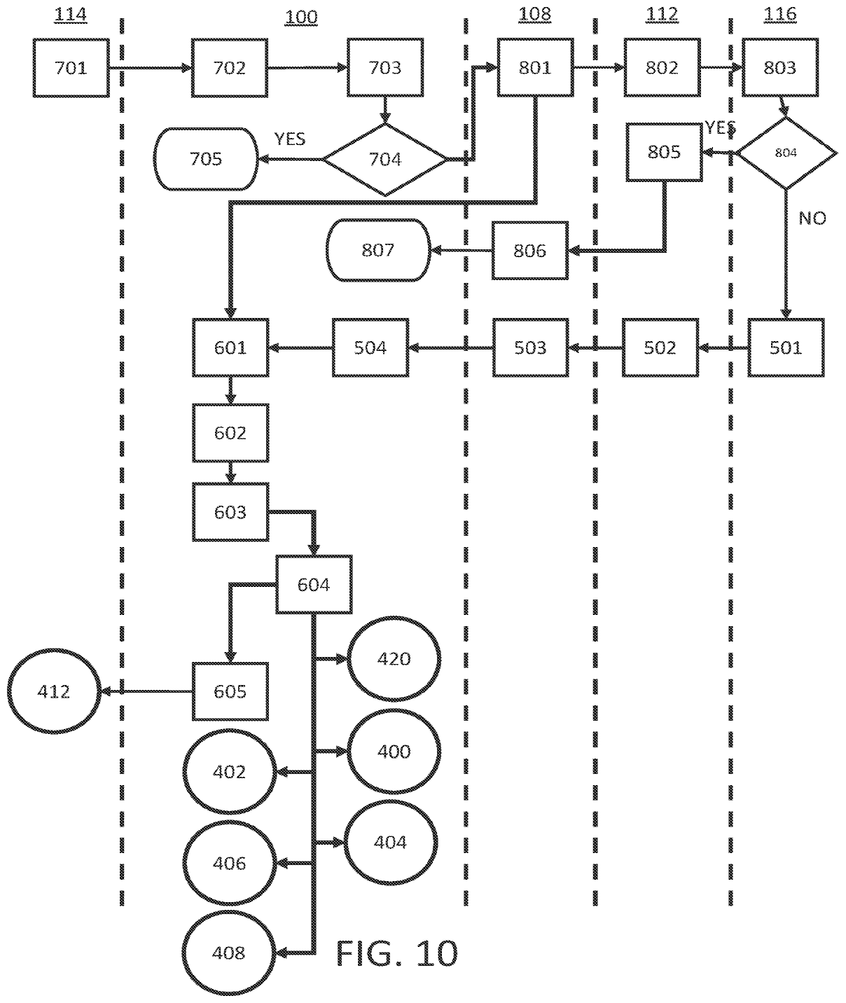

FIG. 10 depicts a method for processing chargebacks.

In another embodiment the payer 114 can initiate a chargeback against a charge on their payment source. The rebilling system 100 must route and settle the chargeback, with respect to markups, sales taxes, fees, and other refund policies configured in the rebilling system 100.

It will be appreciated that the Chargeback process is an extension of the Refund process as depicted in FIG. 9. The Chargeback method adds functionality for a payer (or customer) to initiate a chargeback and also introduces dispute resolution functionality.

In this embodiment the payer (or customer) is capable of initiating 701 a chargeback through their payment network. The rebilling system 100 receives 702 the chargeback request and begins the chargeback process.

First the rebilling system 100 retrieves 703 the charge record associated with the chargeback. The rebilling system 100 then uses the dispute resolution functionality to determine whether to dispute 704 the charge. The dispute resolution functionality uses either automated business logic or a manual decision by the virtual payment card Owner (i.e., the payer) or a combination of the two.

If the rebilling system 100 or the issuer 108 decides to dispute 705 the chargeback, the system enters a manual chargeback dispute resolution process with the payer that is out of scope of this disclosure. In some embodiments, the system may automatically collect a dossier of records and information to support the dispute.

If the rebilling system 100 accepts the chargeback, a new chargeback to the merchant is created for the initial charge request. This effectively forwards 801 the chargeback request to the merchant 116. In this embodiment the rebilling system 100 is configured to automatically collect a dossier of records and information to support the dispute.

The chargeback request is then transmitted 802 through the payment network to the merchant 116.

The merchant's billing system receives 803 the chargeback request and processes it. Part of the processing involves the merchant's system deciding to dispute 804 the chargeback request. If the merchant's system decides to challenge the chargeback request the merchant transmits 805 the dispute back to the rebilling system 100 through the issuer 108 (and its payment network 115). That is, the merchant 116 delegates 806 the dispute resolution to the rebilling system 100.

If the merchant 116 disputes the chargeback then rebilling system 100 initiates a dispute resolution process 807. In this embodiment the system enters a manual chargeback dispute resolution process with the merchant that is out of the scope of this disclosure. In some embodiments, the system may automatically collect a dossier of records and information to support the dispute.

If, however, the merchant 116 decides to not dispute the chargeback then the refund process of FIG. 9 is performed to refund the amount, minus any non-refundable fees (if any) to the payer 114 (or customer).

### CLAUSES

The following clauses are offered as further description of the examples of the method and apparatus. Any one or more of the following clauses may be combinable with any another one or more of the following clauses and/or with any subsection or a portion or portions of any other clause and/or combination and permutation of clauses. Any one of the following clauses may stand on its own merit without having to be combined with any other clause or any portion of any other clause, etc. Clause 1: A rebilling method, comprising: associating a payment source and a payer with a virtual payment card, the virtual payment card from an issuer, and, the payment source provided by the payer; receiving a charge for a subscription fee, the subscription fee for a subscription merchandise for the payer, the subscription merchandise provided by a merchant, the charge applied to the virtual payment card for the subscription fee initiated by the merchant, through a payment network, the charge received by the issuer of the virtual payment card; determining the payer and a markup for each payer related to the subscription fee; calculating a total payer charge amount for each payer from the subscription fee and the markup for each payer; determining a portion amount of the total payer charge amount to be charged to each payment source of the payer; charging the portion amount to the payment source; determining if the charge is authorized. Clause 2: The rebilling method of any of the clauses, further comprising: if the charge is authorized: authorizing the charge for the amount of the subscription fee to the issuer; otherwise: declining authorization of the charge to the issuer. Clause 3: The rebilling method of any of the clauses, further comprising: transferring funds equal to the subscription fee from a rebilling float fund to the merchant fund, through the payment network. Clause 4: The rebilling method of any of the clauses, further comprising: transferring funds equal to the portion amount from a payer fund to a settlement fund; transferring funds equal to the markup to a markup fund; transferring funds equal to the subscription fee to a rebilling float fund. Clause 5: The rebilling method of any of the clauses, wherein: the markup is any one or more of a payer markup, a reseller markup, a distributor markup, a tax, a fees markup, a discount markup, or no markup. Clause 6: The rebilling method of any of the clauses, wherein, the markup is determined by the payer or a rebilling system. Clause 7: The rebilling method of any of the clauses, wherein, the payment sources comprises any one of a credit card, a debit card, an automated clearing house account, or electronic fund transfer account. Clause 8: The rebilling method of any of the clauses, further comprising: calculating a total charge amount from each of the total payer charge amount. Clause 9: The rebilling method of any of the clauses, wherein, the step of determining if the charge is authorized, comprises: calculating if each payment source for each payer in aggregate, or, the rebilling float fund, has funds less than the total charge amount; if no, then authorizing the charge; if yes, then declining the charge. Clause 10: The rebilling method of any of the clauses, wherein, the step of determining if the charge is authorized, comprises: calculating if each payment source for each payer in aggregate, or, the rebilling float fund, has funds less than the total charge amount; if no, then, authorizing the charge; if yes, then, determining if the payer qualifies for a credit; if yes, then authorizing the charge, and associating the credit with the payer; and if no, then declining the charge. Clause 11: The rebilling method of any of the clauses, further comprising: receiving a merchant identification with the charge; wherein, the step of determining if the charge is authorized, comprises: determining if the merchant identification is not the same as a stored merchant identification, or, the merchant identification is not being received for the first time; if no, then authorizing the charge. if yes, then declining the charge. Clause 12: The rebilling method of any of the clauses, wherein, the step of determining if the charge is authorized, comprises: determining if the virtual payment card has not been cancelled, or, the virtual payment card has not been declined by the issuer; if no, then authorizing the charge; if yes, then declining the charge. Clause 13: The rebilling method of any of the clauses, wherein, the payer is a reseller to an end customer or another payer. Clause 14: The rebilling method of any of the clauses, further comprising: associating an additional payer and an additional payment source with the virtual payment card. Clause 15: The rebilling method of any of the clauses, further comprising: removing the payer and the payment source associated with the virtual payment card. Clause 16: The rebilling method of any of the clauses, wherein, the virtual payment card is not permanently associated to the payment source and may be associated with a new payment source. Clause 17: The rebilling method of any of the clauses, wherein, the virtual payment card is a security token issued by the issuer, and the method does not require PCI (Payment Card Industry) compliance since no credit card information is stored. Clause 18: The rebilling method of any of the clauses, wherein, the markup is applied, and a billing system of the merchant is not modified due to the use of the payment network. Clause 19: The rebilling method of any of the clauses, wherein, the authorization of the charge by the method occurs without decision making input from the issuer, payment network, and the merchant. Clause 20: The rebilling method of any of the clauses, wherein, the authorizing and the charging occur almost simultaneously. Clause 21: The method of any of the clauses, further comprising: subscribing to a subscription merchandise with a subscription fee provided by a merchant with the virtual payment card on behalf of the payer. Clause 22: The method of any of the clauses, further comprising: determining that the payment source has failed, or, the payment source is unavailable; determining if there is an alternate payment source, the alternate payment source selected from the payment sources for the payer; and if yes, then charging the portion amount to the alternate payment source. Clause 23: The method of any of the clauses, wherein, the step of charging the portion amount to the payment source, further comprises: determining that the payment source has failed, or, the payment source is unavailable; determining if there is an alternate payment source, the alternate payment source selected from the payment sources for the payer; and if yes, then charging the portion amount to the alternate payment source. Clause 24: The method of any of the clauses, further comprising: determining that the payer has no available payment sources; determining if there is an alternate payer, the alternate payer selected from the payers for the virtual payment card; if yes, then applying the portion amount to the payment source of the alternate payer, and, associating the portion amount as a recoupable amount owed by the payer to the alternate payer; Clause 25: The method of any of the clauses, wherein, the step of determining a portion amount of the total payer charge amount to be charged to each payment source of the payer, further comprises: determining that the payer has no available payment sources; determining if there is an alternate payer, the alternate payer selected from the payers for the virtual payment card; if yes, then, applying the portion amount to the payment source of the alternate payer, and, associating the portion amount as a recoupable amount owed by the payer to the alternate payer. Clause 26: The method of any of the clauses, further comprising: determining when the payer will allow a recoupable amount to be repayable to the alternate payer; if the payer will allow the recoupable amount to be repayable, then, calculating a total recoupable amount from the recoupable amount and a recoupable markup, and, charging the payment source of the payer the total recoupable amount; Clause 27: The method of any of the clauses, further comprising: collecting the total recoupable amount from the payment source of the payer; refunding the alternate payer the total recoupable amount. Clause 28: A rebilling system, comprising: a database; a server, the server operatively connected to the database, the server configured to: associate a payment source and a payer with a virtual payment card, the virtual payment card from an issuer, and, the payment source provided by the payer; receive a charge for a subscription fee, the subscription fee for a subscription merchandise for the payer, the subscription merchandise provided by a merchant, the charge applied to the virtual payment card for the subscription fee initiated by the merchant, through a payment network, the charge received by the issuer of the virtual payment card; determine the payer and a markup for each payer related to the subscription fee; calculate a total payer charge amount for each payer from the subscription fee and the markup for each payer; determine a portion amount of the total payer charge amount to be charged to each payment source of the payer; charge the portion amount to the payment source; determine if the charge is authorized. Clause 29: The rebilling system of any of the clauses, further configured to: if the charge is authorized: authorize the charge for the amount of the subscription fee to the issuer; otherwise: decline authorization of the charge to the issuer. Clause 30: The rebilling system of any of the clauses, further configured to: transfer funds equal to the subscription fee from a rebilling float fund to the merchant fund, through the payment network. Clause 31: The rebilling system of any of the clauses, further configured to: transfer funds equal to the portion amount from a payer fund to a settlement fund; transfer funds equal to the markup to a markup fund; transfer funds equal to the subscription fee to a rebilling float fund; Clause 32: The rebilling system of any of the clauses, wherein: the markup is any one or more of a payer markup, a reseller markup, a distributor markup, a tax, a fees markup, a discount markup, or no markup. Clause 33: The rebilling system of any of the clauses, wherein, the markup is determined by the payer or a rebilling system. Clause 34: The rebilling system of any of the clauses, wherein, the payment source comprises any one of a credit card, a debit card, an automated clearing house account, or electronic fund transfer account. Clause 35: The rebilling system of any of the clauses, further configured to: calculate a total charge amount from each of the total payer charge amount. Clause 36: The rebilling system of any one of the clauses, wherein, the configuration of determine if the charge is authorized, comprises: calculate if each payment source for each payer in aggregate, or, the rebilling float fund, has funds less than the total charge amount; if no, then authorize the charge; if yes, then decline the charge. Clause 37: The rebilling system of any one of the clauses, wherein, the configuration of determine if the charge is authorized, comprises: calculate if each payment source for each payer in aggregate, or, the rebilling float fund, has funds less than the total charge amount; if no, then, authorize the charge; if yes, then, determine if the payer qualifies for a credit; if yes, then authorize the charge, and associating the credit with the payer; and if no, then decline the charge. Clause 38: The rebilling system of any of the clauses, further configured to: receive a merchant identification with the charge; wherein, the configuration of determine if the charge is authorized, comprises: determine if the merchant identification is not the same as a stored merchant identification, or, the merchant identification is not being received for the first time; if no, then authorize the charge; if yes, then decline the charge. Clause 39: The rebilling system of any of the clauses, wherein, the configuration of determine if the charge is authorized, comprises: determine if the virtual payment card has not been cancelled, or, the virtual payment card has not been declined by the issuer; if no, then authorize the charge; if yes, then decline the charge. Clause 40: The rebilling system of any of the clauses, wherein, the payer is a reseller to an end customer or another payer. Clause 41: The rebilling system of any of the clauses, further configured to: associate an additional payer and an additional payment source with the virtual payment card. Clause 42: The rebilling system of any of the clauses, further configured to: remove the payer and the payment source associated with the virtual payment card. Clause 43: The rebilling system of any of the clauses, wherein, the virtual payment card is not permanently associated to the payment source and may be associated with a new payment source. Clause 44: The rebilling system of any of the clauses, wherein, the virtual payment card is a security token issued by the issuer, and the system does not require PCI (Payment Card Industry) compliance since no credit card information is stored. Clause 45: The rebilling system of any of the clauses, wherein, the markup is applied, and a billing system of the merchant is not modified due to the use of the payment network. Clause 46: The rebilling system of any of the clauses, wherein, the authorization of the charge by the system occurs without decision making input from the issuer, payment network, and the merchant. Clause 47: The rebilling system of any of the clauses, wherein, the authorize and the charge occur almost simultaneously. Clause 48: The system of any of the clauses, further configured to: subscribe to a subscription merchandise with a subscription fee provided by a merchant with the virtual payment card on behalf of the payer. Clause 49: The system of any of the clauses, further configured to: determine that the payment source has failed, or, the payment source is unavailable; determine if there is an alternate payment source, the alternate payment source selected from the payment sources for the payer; and if yes, then, charge the portion amount to the alternate payment source. Clause 50: The system of any of the clauses, wherein, the configuration of charging the portion amount to the payment source, further comprises: determine that the payment source has failed, or, the payment source is unavailable; determine if there is an alternate payment source, the alternate payment source selected from the payment sources for the payer; and if yes, then, charge the portion amount to the alternate payment source. Clause 51: The system of any of the clauses, further configured to: determine that the payer has no available payment sources; determine if there is an alternate payer, the alternate payer selected from the payers for the virtual payment card; if yes, then, apply the portion amount to the payment source of the alternate payer, and, associate the portion amount as a recoupable amount owed by the payer to the alternate payer. Clause 52: The system of any of the clauses, wherein, the configuration of determine a portion amount of the total payer charge amount to be charged to each payment source of the payer, further comprises: determine that the payer has no available payment sources; determine if there is an alternate payer, the alternate payer selected from the payers for the virtual payment card; if yes, then, apply the portion amount to the payment source of the alternate payer, and, associate the portion amount as a recoupable amount owed by the payer to the alternate payer. Clause 53: The system of any one of the clauses, further configured to: determining when the payer will allow a recoupable amount to be repayable to the alternate payer; if the payer will allow the recoupable amount to be repayable, then, calculating a total recoupable amount from the recoupable amount and a recoupable markup, and, charging the payment source of the payer the total recoupable amount. Clause 54: The system of any one of the clauses, further configured to: collect the total recoupable amount from the payment source of the payer; refund the alternate payer the total recoupable amount. Clause 55: The method of any one of the clauses, wherein, the recoupable markup is one of a penalty markup, a recoupable fee markup, an interest markup, and no markup. Clause 56: The system of any one of the clauses, wherein, the recoupable markup is one of a penalty markup, a recoupable fee markup, an interest markup, and no markup.

The operations of the methods presented above are intended to be illustrative. In some embodiments, methods may be accomplished with one or more additional operations not described, and/or without one or more of the operations discussed. Additionally, the order in which the operations of methods as described above are not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. A rebilling method comprising:
associating, by a rebilling system operating on a server, a virtual payment card that is issued by an issuing system with a first party that operates the rebilling system;
inputting, by the rebilling system, the virtual payment card at a subscription merchandise merchant's pre-existing payment card capture interface, to purchase, by the first party, the subscription merchandise merchant's subscription merchandise on behalf of a second party, the second party being an end customer of the subscription merchandise, such that the subscription merchandise merchant records the virtual payment card in a payment card record of a billing system of the subscription merchandise merchant;
wherein the first party is an owner of the virtual payment card, such that business rules for billing, access to, and control of the virtual payment card is configured by the first party,
wherein either the first party, a second party, or both, according to the billing rules configured by the first party, control a payment source for the virtual payment card, such that the first party, the second party or both, according to the business rules is a payer for the virtual payment card;
wherein business rules for billing, access, and control of the virtual payment card are enforced and managed by the rebilling system,
in which the business rules for billing, access and control of the virtual payment card are dynamically configurable by the owner of the virtual card through the rebilling system without a change to the payment card record in the billing system of the subscription merchandise merchant;
processing, at the rebilling system, through the issuing system, and delegated to the rebilling system by the issuing system, a charge request associated with the virtual payment card over a payment network for the subscription merchandise to and from the subscription merchandise merchant such that, according to the billing rules for the virtual payment card, the payment source for the virtual payment card is debited to satisfy payment for the subscription merchandise;
providing, at the rebilling system, after the processing, a means to receive an instruction from either the first party or the second party to change ownership of the subscription by reassigning the owner of the virtual payment card to the second party, such that, in response to receipt of the instruction to reassign the owner of the virtual payment card to the second party, the rebilling system:
updates a rebilling system database to change the owner of the virtual payment card from the first party to the second party, granting the second party control of configuration of the virtual payment card;
detaches first party payment sources controlled by the first party from the virtual payment card; and
attaches second party payment sources controlled by the second party to the virtual payment card.

2. The rebilling method of claim 1, wherein the processing further comprises:
determining, by the rebilling system, if according to the business rules for the virtual payment card controlled by the first party, the charge request is authorized, such that if the charge is authorized the payment source for the virtual payment card controlled by the second party is debited to satisfy payment for the subscription merchandise and if the charge request is not authorized, the payment source controlled by the second party is not debited to satisfy payment for the subscription merchandise.

3. The rebilling method of claim 1, wherein the processing further comprises:
transferring funds equal to a subscription fee defined by the charge request from a rebilling float fund to a merchant fund, through the payment network.

4. The rebilling method of claim 1, wherein the processing further comprises:
transferring funds equal to a portion amount from a payer fund to a settlement fund;
transferring funds equal to a markup to a markup fund; and
transferring funds equal to a subscription fee to a rebilling float fund.

5. The rebilling method of claim 4 wherein:
the markup is any one or more of a payer markup, a reseller markup, a distributor markup, a tax, a fees markup, a discount markup, or no markup.

6. The rebilling method of claim 4, wherein, the markup is determined by the payer or the rebilling system.

7. The rebilling method of claim 1, wherein, the payment sources comprises any one of a credit card, a debit card, an automated clearing house account, or electronic fund transfer account.

8. The rebilling method of claim 1, wherein the processing further comprises:
calculating a total charge amount by aggregating a total charge amount from the first and second party.

9. The rebilling method of claim 2, wherein, the step of determining if the charge request is authorized, comprises:
calculating if each payment source for each payer in aggregate, or, a rebilling float fund, has funds less than the total charge amount;
if no, then authorizing the charge;
if yes, then declining the charge.

10. The rebilling method of claim 8, wherein, the step of determining if the charge is authorized, comprises:
calculating if each payment source for each payer in aggregate, or, the rebilling float fund, has funds less than the total charge amount;
if no, then, authorizing the charge;
if yes, then, determining if the payer qualifies for a credit;
if yes, then authorizing the charge, and associating the credit with the payer; and
if no, then declining the charge.

11. The rebilling method of claim 2, further comprising:
receiving a merchant identification with the charge; wherein, the step of determining if the charge is authorized, comprises:
determining if the merchant identification is not the same as a stored merchant identification, or, the merchant identification is not being received for the first time;
if no, then authorizing the charge;
if yes, then declining the charge.

12. The rebilling method of claim 2, wherein, the step of determining if the charge is authorized, comprises:
determining if the virtual payment card has not been cancelled, or, the virtual payment card has not been declined by the issuer;
if no, then authorizing the charge;
if yes, then declining the charge.

13. The rebilling method of claim 1, wherein, the first party is a payer and is a reseller to an end customer or another payer.

14. The rebilling method of claim 1, further comprising:
associating a third party with the virtual payment card as an additional payer and with an additional payment source with the virtual payment card.

15. The rebilling method of claim 1, wherein the payment source for the virtual payment card is a first payment source, the method further comprising:
detaching the first payment source from the virtual payment card; and
associating a second payment source with the virtual payment card.

16. The rebilling method of claim 1, wherein, the virtual payment card is a security token issued by the issuer, and the method does not require PCI (Payment Card Industry) compliance since no credit card information is stored.

17. The rebilling method of claim 4, wherein, the markup is applied, and a billing system of the subscription merchandise merchant is not modified due to the use of the payment network.

18. The rebilling method of claim 2 wherein, the authorization of the charge by the method occurs without decision making input from the issuer, payment network, and the subscription merchandise merchant.

19. The rebilling method of claim 2, wherein, the authorizing and the charging occur contemporaneously.

20. The method of claim 1, wherein the subscription merchandise has a subscription fee.

21. The method of claim 2, further comprising:
determining that the payment source has failed, or, the payment source is unavailable;
determining if there is an alternate payment source, the alternate payment source selected from the payment sources for the payer; and
if yes, then charging the portion amount to the alternate payment source.

22. The method of claim 2, wherein, the step of charging the portion amount to the payment source, further comprises:
determining that the payment source has failed, or, the payment source is unavailable;
determining if there is an alternate payment source, the alternate payment source selected from the payment sources for the payer; and
if yes, then charging the portion amount to the alternate payment source.

23. The method of claim 4, further comprising:
determining that the payer has no available payment sources;
determining if there is an alternate payer, the alternate payer selected from the payers for the virtual payment card;
if yes, then applying the portion amount to the payment source of the alternate payer, and, associating the portion amount as a recoupable amount owed by the payer to the alternate payer.

24. The method of claim 4, wherein, the step of determining a portion amount of the total payer charge amount to be charged to each payment source of the payer, further comprises:
determining that the payer has no available payment sources;
determining if there is an alternate payer, the alternate payer selected from the payers for the virtual payment card;
if yes, then, applying the portion amount to the payment source of the alternate payer, and,
associating the portion amount as a recoupable amount owed by the payer to the alternate payer.

25. The method of claim 1, further comprising:
determining when the payer will allow a recoupable amount to be repayable to the alternate payer;
if the payer will allow the recoupable amount to be repayable, then, calculating a total recoupable amount from the recoupable amount and a recoupable markup, and, charging the payment source of the payer the total recoupable amount.

26. The method of claim 25, further comprising:
collecting the total recoupable amount from the payment source of the payer;
refunding the alternate payer the total recoupable amount.

27. A rebilling system, comprising:
a database;
a server, the server operatively connected to the database, the server configured to:
associate a virtual payment card that is issued by an issuer with a first party that operates the rebilling system;
input the virtual payment card at a subscription merchandise merchant's pre-existing payment card capture interface, to purchase, by the first party, the subscription merchandise merchant's subscription merchandise on behalf of a second party, the second party being an end customer of the subscription merchandise, such that the subscription merchandise merchant record the virtual payment card in a payment card record of the subscription merchandise merchant;
wherein the first party is an owner of the virtual payment card, such that business rules for billing, access to, and control of the virtual payment card is configured by the first party,
wherein either the first party, a second party, or both, according to the billing rules configured by the first party, control a payment source for the virtual payment card,
wherein business rules for billing, access, and control of the virtual payment card are enforced and managed by the rebilling system,
in which the business rules for billing, access and control of the virtual payment card are dynamically configurable by the owner of the virtual card through the rebilling system without a change to the payment card record in the billing system of the subscription merchandise merchant;
process, through the issuing system, and delegated to the rebilling system by the issuing system, a charge request associated with the virtual payment card over a payment network for the subscription merchandise to and from the subscription merchandise merchant such that, according to the billing rules for the virtual payment card, the payment source for the virtual payment card is debited to satisfy payment for the subscription merchandise;
provide, after the processing, a means to receive an instruction from either the first party or the second party to change ownership of the subscription by reassigning the owner of the virtual payment card to the second party, such that, in response to receipt of the instruction to reassign the owner of the virtual payment card to the second party, the rebilling system:
updates the database to change the owner of the virtual payment card from the first party to the second party, granting the second party control of configuration of the virtual payment card;
detaches payment sources controlled by the first party from the virtual payment card; and
attaches second party payment sources controlled by the second party to the virtual payment card.

28. The rebilling method of claim 1, wherein the subscription merchandise merchant is a first subscription merchandise merchant, the merchant's subscription merchandise is a first subscription merchandise, and the charge request is a first charge request, the method further comprising:
inputting, by the rebilling system, the virtual payment card at a second subscription merchandise merchant's pre-existing payment card capture interface, to purchase, by the first party, the second subscription merchandise merchant's subscription merchandise on behalf of the second party;
processing, at the rebilling system, through the issuing system, and delegated to the rebilling system by the issuing system, a second charge request associated with the virtual payment card over a payment network for the second subscription merchandise to and from the subscription merchandise merchant such that, according to the billing rules for the virtual payment card, the payment source for the virtual payment card is debited to satisfy payment for the second subscription merchandise.

29. The rebilling method of claim 1, wherein the subscription merchandise merchant is a first subscription merchandise merchant, and the merchant's subscription merchandise is a first subscription merchandise, the method further comprising:
inputting, by the rebilling system, the virtual payment card at a second subscription merchandise merchant's pre-existing payment card capture interface, to purchase, by the first party, a second subscription merchandise from the second subscription merchandise merchant on behalf of the second party;
wherein the processing further comprises:
receiving, at the rebilling system, a first charge for a first subscription fee from the issuing system for the first subscription merchandise for the payer, the first subscription merchandise provided by the first subscription merchandise merchant, wherein the first charge is provided by the issuing system in response to a first charge request applied to the virtual payment card for the first subscription fee initiated by the first subscription merchant, through the payment network;
receiving, at the rebilling system, a second charge for a second subscription fee from the issuing system for the second subscription merchandise for the payer, the second subscription merchandise provided by the second subscription merchant, the second charge is provided by the issuing system in response to a second charge request applied to the virtual payment card for the second subscription fee initiated by the second subscription merchant;
determining a first markup for the payer related to the first subscription fee and a second markup for the payer related to the second subscription fee;
calculating a first total payer charge amount for the payer from the first subscription fee and the first markup, and a second total charge amount for the payer from the second subscription fee and the second markup for the payer;
determining, at the rebilling system, a first portion amount of the first total payer charge amount and a second portion of the second total charge amount to be charged to the payment source controlled by the payer;
charging, at the rebilling system, the first portion amount and the second portion amount to the payment source controlled by the payer;
determining, at the rebilling system, if the charge for the first portion amount to the payment source controlled by the second party is authorized;
determining, at the rebilling system, if the charge for the second portion amount to the payment source controlled by the second party is authorized;
providing, from the rebilling system, authorization for the first charge for the amount of the first subscription fee to the issuing system if the charge for the first portion amount is determined to be authorized and providing, from the rebilling system, a declining of authorization for the first charge for the amount of the first subscription fee to the issuing system if the charge for the first portion amount is not determined to be authorized; and
providing, from the rebilling system, authorization for the second charge for the amount of the second subscription fee to the issuing system if the charge for the second portion amount is determined to be authorized and providing, from the rebilling system, a declining of authorization for the second charge for the amount of the second subscription fee to the issuing system if the charge for the second portion amount is not determined to be authorized.

30. The rebilling system of claim 1, wherein the updating of the rebilling system database to change the owner of the virtual payment card from the first party to the second party further comprises modifying the business rules such that access to the virtual payment card by the first party is disabled.
